(19) United States
(12) Patent Application Publication
(10) Pub. No.: US 2016/0371917 A1
(43) Pub. Date: Dec. 22, 2016

(54) CAPTURING AND PRESENTING PERIPHERAL INFORMATION IN ELECTRONIC GAMES

(71) Applicant: NOBOTGAMES, INC., Pomona, CA (US)

(72) Inventors: Shuo Yang, Pomona, CA (US); Matthew Valadez, Ontario, CA (US); Xue Huang, Montclair, CA (US)

(21) Appl. No.: 14/741,127

(22) Filed: Jun. 16, 2015

(51) Int. Cl. G07F 17/32; G06F 3/16; G06F 3/01; G06F 3/048; G06F 3/0481

(52) U.S. Cl. CPC G07F 17/3204; G07F 17/3293; G07F 17/3272; G06F 3/048; G07F 17/3209; G06F 3/04817; G07F 17/3206; G07F 17/323; G06F 3/017; G06F 3/013; G06F 3/015; G06F 3/16

(57) ABSTRACT

A method of providing feedback during an electronic poker game between a first player using a first electronic device and a second player using a second electronic device includes receiving, from the first electronic device, an input corresponding to a contemplated interaction with a first user interface (UI) element but insufficient to complete the contemplated interaction and presenting, at the second electronic device, a graphical representation of the contemplated interaction in proximity to a different second UI element.

### FIELD OF THE INVENTION

The field of the invention is interactive electronic game technologies.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

As electronic gaming has become increasingly popular, one trend has been to create interactive electronic implementations of popular traditional games such as poker, blackjack, mahjong, dominoes, etc. Computerized versions of these games have many advantages over traditional face-to-face versions. For example, using a computer or mobile device, players can compete against players from around the world, at any time they desire, and from almost any location

However, many of these traditional games have elements that are missing in an electronic format, and as a result may not be as engaging as face-to-face versions. In the game of poker, for instance, it is important to watch the behavior of other players for changes in behavior or demeanor that might give clues to the other players' hands. For example, a player might be able to determine the quality of a player's cards based on the way the other player handles her chips, the way she shuffles her cards, or from the expression on her face. These external behaviors, or “tells,” are usually not directly related to the game, but can be a very important strategic component of games—particularly gambling games. Similar tells may exist for other traditional face-to-face games. As a result, electronic implementations of games often lack many elements of a traditional face-to-face game.

There have been many attempts to make electronic games more realistic. U.S. Pat. No. 7,309,280 to Toyoda (“Toyoda”), for example, discloses a game machine (for an arcade, game hall, casino, etc.) that allows multiple players to see one other's facial expressions. The game machine captures changes in expressions from the players with a camera, and displays those changes to other players. However, although the game machine captures images of the players' faces, the captured photos often look very different from the user interface of the game itself. This difference can be jarring for players. Additionally, the game machine in Toyoda requires all players to be physically present at the same game machine in order to play against one another.

The game machine described in U.S. Patent Application Publication No. 2003/0199316 to Miyamoto et al. (“Miyamoto”) overcomes some of the deficiencies in Toyoda. Miyamoto's game machine (also for an arcade, casino, or similar location) is capable of interpreting a player's voice and actions to determine that player's psychological state. The machine can then alter its response based on the detected psychological state of the player. However, the system in Miyamoto does not relay the voices and actions from one player to another player.

U.S. Pat. No. 7,507,157 to Vale et al. represents a significant improvement over Toyoda and Miyamoto. First, Vale teaches an interactive gaming environment that can represent peripheral information or tells by players to other participants. For example, when the player has completed an action (e.g., reordering cards), that action can be relayed to other players. Second, Vale teaches an interactive gaming environment where players can play on a remote computer. However, Vale's system only captures players' completed actions and provides only simplified interpretations of the player's actions (e.g., displaying a single icon to suggest that a player is counting chips or an icon to suggest that a player is disinterested).

Thus, there is still a need for improved interactive electronic game technologies that can better detect and convey a player's emotional state to other players.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY OF THE INVENTION

The inventive subject matter provides apparatus, systems and methods in which a game player's emotional profile can be derived and presented to other players in an electronic, networked game environment, thus providing emotional feedback about the game player to other players who may not be able to see the game player. The emotional profile of the player can be detected, derived, and presented to other players in the game in various ways.

Under one approach, every critical interaction with an object in the game requires a series of inputs before that critical interaction is completed. The series of inputs for each critical interaction is designed such that a contemplated interaction with the object could be predicted without the player completing the entire series. Preferably, only the first one or two inputs from the player are sufficient to predict the contemplated interaction. Once a contemplated interaction is predicted, a representation of such a contemplated interaction could be presented to other players. In some embodiments, the extent to which the series of inputs associated with the contemplated interaction is completed is also presented to the other players. As such, other players can see how the player has interacted with the game object in a certain way, and/or even to what extent the player has interacted with the game object even though the player does not actually complete the interaction with the game object. A plurality of representations (e.g., a plurality of graphic representations, auditory representations, or tactile representations) of a player's movements could be associated with each contemplated interaction to fully express the extent to which a player has completed the contemplated interaction.

In some embodiments, a first electronic device receives inputs from a game player corresponding with a contemplated interaction with a user-interface element (“UI element”) within a game. As used herein, a “UI element” is an element within a game that a player can interact with, such as a player's chips, cards, totem, or avatar. Such UI elements are typically used to trigger changes in the game, such as moving chips forward to raise a bet or folding a hand, but could be used simply to trigger changes in the player's user interface environment, such as moving a totem from a right side of the player to the left side of the player. A contemplated interaction can be considered to be inputs provided by the game player in anticipation of or in the preparation of the execution of a discrete in-game action, but does not necessarily include inputs that actually cause the execution of the in-game action. Series of inputs that cause execution of an in-game interaction are considered “sufficient” and series of inputs that fail to cause execution of an in-game interaction are considered “insufficient.” While the game player interacts with a UI element presented by the game running on a first device, the system causes a second game player using a second device to receive a translated representation of the first game player's actions via one or more corresponding UI elements on a second device.

In a game of electronic poker, the UI element can be an interactive object in the poker game (e.g., a player's cards, a player's chips, a staging area, certain sections of a poker table, and user interface elements representative of player actions of a poker game). A series of interactions with a UI element are typically needed to sufficiently complete a contemplated interaction. Contemplated interactions include, for example, revealing a hand of cards, calling a bet, checking a bet, placing a bet, going “all-in,” selecting a quantity of a chip type, moving a card, folding a hand of cards, and selecting a chip type.

Contemplated inputs received by the first electronic device that could be translated into representations by the system could be one or any combination of, for example, a gesture, an amount of actuation, and an amount of pressure applied. An input could be interpreted as a gesture received via a device that can detect one or more of a two-dimensional motions relative to a surface (e.g., a touch screen). The game can translate such action(s) into representations of changes to UI elements within the displayed game. The gesture can depend on one or more of the following: a position where the gesture is initiated, a direction of travel along a two-dimensional plane, a length of travel along a two-dimensional plane, a speed of travel along a two-dimensional plane, an acceleration of travel along a two-dimensional plane, a degree of actuation of an input device, an amount of pressure applied, a force applied, a time of travel, etc. These values can be located along a spectrum or along multiple spectrums of possible values.

A representation of the contemplated interaction performed by the first player could be presented via a second electronic device, such as an electronic device or other user interface of a second player participating in the same game. Such representations could be graphical in nature, but could be auditory, tactile, olfactory, or could be communicated through some other sense. In some embodiments, the representation will allow the second player to determine where the first player started initiating an interaction (via the contemplated interaction), even if the interaction was never ultimately caused to be executed by the first player. The representation could be an animation representative of the contemplated interaction, or could be a series of translated animations.

In some embodiments, the presentation of the graphical representation of the contemplated interaction via the second electronic device can be in real-time, and thus the second player can watch or otherwise witness the interactions of the first player “live”.

In some embodiments, biometrics associated with participants in a game can be detected and presented to other participants. Such biometrics can be detected via one or more wearable biometric devices. Contemplated biometrics can include a heart rate, a moisture level (for detecting how much a player sweats), a voice pattern (e.g., pitch, tone, volume, etc.), a hand movement, and a number of blinks. The biometrics can be presented simultaneously with the presentation of a graphical representation of a contemplated interaction. For example, in a poker game, a graphical representation of a player contemplating going “all in” with their remaining chips can be presented together with the player's heart rate during the execution of the contemplated interaction to the other players in the game via their respective electronic devices.

Under another approach, an electronic poker player can temporarily place a chip combination that represents a chip amount in a staging area of a graphical user interface before executing a turn. The staging area allows the player to contemplate on a betting amount for the turn before committing to the bet. Preferably, the player can make changes to the chip amount by adding chip(s) to, removing chip(s) from, or replacing chip(s) in the staging area before committing to the bet. In some embodiments, information of the chip amount that is placed in the staging area is provided to the other players and any changes to the chip amount will also be provided to the other players as soon as the changes are made. For example, a number indicating the current amount of chips the player has placed in the staging area could be shown to other players, or chips that represent the chip amount (if one were to add the chips together, the sum would equal the number of chips placed in the staging area) could be shown to other players.

In some embodiments, the contemplated interactions of a first player can be presented to other players via the use of a staging area within an interactive gameplay environment. As used herein, an “interactive gameplay environment” is used to mean a game environment having UI elements that a player could interact with via one or more user interfaces. For example, the interactive gameplay environment could be one or more screens that display the game environment and one or more UI elements. In one example, the interactive gameplay environment is a touch screen used during gameplay of an interactive poker game. The gameplay environment represented to the players on their respective electronic devices could include graphical elements corresponding to elements of gameplay (e.g., gameplay actions, gameplay items, etc.) that are interactive. For example, some graphical elements can be moved or altered within the interactive gameplay environment. In an electronic poker game, examples of these graphical elements can include poker chips and playing cards.

The staging area within an interactive gameplay environment is an area within which the movements of (and interactions with) graphical elements by a player are presented to the other players in the game.

In some embodiments, one way of providing emotional feedback during an electronic poker game between two or more players is to provide such emotional feedback through each player's own device. One player's device can display one or more graphical elements in addition to the staging area. The device can allow the player to move the graphical element into the staging area without completing the player's turn. The device could then send a signal to another player's device in response to detecting the movement of the graphical element into the staging area. The second player's device could then display the element(s) that the first player is contemplating using during his turn. In some embodiments, the element could animate, move, or change in a manner that indicates the type and quality of the interaction between the player and the element. In the case of an electronic poker game, the second player could see the first player contemplating to play a card by seeing the card move closer to a play position, or see the first player move a poker chip in anticipation of betting that chip, etc. In some embodiments, the first player's device can detect the direction and the force of the first player's movement and send a signal to the second player's device to display the information associated with the direction and force of the first player's movement. In other embodiments, the first player's device can detect some combination of speed, direction, force, and acceleration of the first player's movement and send a signal to the second player's device to display the information associated with the input variables of the first player's movement.

In some embodiments, the first player's device can be programmed to allow the first player to remove the element from the staging area without completing his turn. The second player's device would show that the first player removed the element from the staging area. Additionally or alternatively, the first player's device could display a notification to complete the turn. The first player could then complete the turn by deciding to keep one element in the staging area.

In some embodiments of the inventive subject matter, the player's device shows a common area for presenting elements that the player cannot control and a personal area for presenting elements that the player can control. Typically elements that the player cannot control are elements that are controlled by other players (e.g., other player's bet chips) or elements that are controlled by the computer system (e.g., dealt cards). In some embodiments, the common area could be a poker table or a defined area of a poker table (e.g., a 2 unit×4 unit area in the center of the poker table).

In some embodiments, the emotional feedback in an electronic poker game can be obtained from a graphical user interface (GUI). The GUI has a common area for presenting game elements that a player cannot control, a personal area for presenting game elements that a player can control, and a staging area that temporarily presents elements that are being used to complete a turn in the game. The GUI can enable a player to either (a) move a game element from the personal area to the staging area without completing a turn, (b) move an element from the staging area back to the personal area, or (c) move a game element from the staging area to a common area of the staging area (e.g., center of the staging area) to complete a turn. The staging area typically looks different from the player contemplating an interaction than other players viewing the player's contemplated interaction. The system could be configured to monitor the player's actions within the staging area and translate one or more of those interactions into one or more representations of the player's actions.

Another approach provides for a graphical user interface (GUI) on a touch-sensitive device. The GUI could have a dial control that allows a player to select different poker chip combinations (which correspond with different monetary amounts) to be used during the player's turn. This GUI configuration could allow for the player to easily see and select different chip combinations. Preferably, each type of chip is represented by a different image or graphical representation, and the GUI displays the image in response to the player's selection on the dial control.

In some aspects of the inventive subject matter, the player can interact with an electronic poker game via a user interface on a device with a touch-sensitive screen. The player can set a chip combination to be used during her turn via a dial control on the screen. The user interface can display graphical representations corresponding to multiple poker chip types in response to the player's selection on the dial. Each chip type can correspond with a different monetary value.

In some embodiments, the user interface can detect a gesture on the screen by the player and then determine a chip combination to be used as a result of the gesture. In some embodiments, the user interface derives a vector, a direction, a speed, an acceleration, a force, and/or a pressure from the gesture.

In some embodiments, the graphical representations are displayed around each a portion of the circumference of the dial control. Each graphical representation could correspond to a distinct range of arc degrees from one another with respect to the dial control. A graphical representation of the UI dial could be replicated to other players on their user interfaces.

Other aspects provide for an additional way of obtaining emotional feedback during an electronic poker game through a minigame. The player is given a minigame, separate from the poker game, to be played while the player is waiting for her turn. The player's actions and/or performance during the minigame can be analyzed to produce an emotional profile. The player's emotional profile can then be displayed to other players (for example, by reflecting the player's emotional profile in her avatar).

In some aspects of the inventive subject matter, a player could be directed to play a minigame during a period when it is not the player's turn, or when the player is not otherwise required to do anything to advance the poker game. In some embodiments, the player could be provided with an incentive (such as a bonus, unlocking an additional feature, etc.) to complete the minigame. In general, feedback from the minigame could advantageously provide other players with additional information. For example, the sequence of inputs by the player while playing the minigame could be analyzed, and an emotional profile based on the analysis could be derived. Another player could be provided with a representation of the emotional profile in real-time.

While the player is not playing, the system could also allow a player to trade in chips when it is not the player's turn, and other players could be able to see a graphical representation of the player's movements while trading in chips. Chip denomination would be part of the game, and the player could commit to changing the chip denomination at any time, altering the number and amount of certain denominations of chips in front of the player.

The emotional profile could be based on an analysis of a player's repetition, speed, change in speed, or difference in speed of a sequence of inputs. In some embodiments, a slight difference could indicate a low level of anxiety, whereas a large difference could indicate a high level of anxiety. Such differences could be provided in representations that are presented to other players.

In some embodiments, a second player could also be provided with a minigame, and the second player's input could be analyzed in a similar manner. In some embodiments, any of the players playing a minigame may not be required to complete the game, and a player could cancel out of a minigame at any time.

By monitoring a player's inputs into a game to generate an emotional profile, and by translating that emotional profile into specific actions, the system effects a transformation of the player's actions into specific representations of the player that are reflected by the game server. A game server is a customized computer that applies each transformation with particularity that have not been performed by prior art game servers. Emotional profiles could be translated not only from a player's conscious actions to complete certain tasks that affect gameplay, but a player's conscious and unconscious actions leading up to complete or incomplete tasks, and a player's unconscious biometric data which provide additional personality ticks and quirks that could translate to a tell for an experienced player. By translating the information into graphical representations that match the look and feel of the game (as opposed to simply recording a video of the player and presenting the video to a user interface), the translated emotional profile elements feel like a natural extension of each player's game avatar, while still conveying information that would be useful to an experienced player.

A combination of the aforementioned modules could be used to provide a novel manner for a plurality of players to play virtualized games with one another in an online environment. For example, a poker game could be constructed wherein a plurality of players access a game session on a centralized server through each player's respective client module. The system could be configured to present a game session of the poker game through the player's user interface such that the player sees her opponent's avatars, cards, and chips on a 3-D virtualized representation of the table, including the player's avatars, cards, and chips. In some embodiments, the player might be able to interact directly with the player's cards and chips by clicking on the game elements using a mouse or a touch screen device, but in preferred embodiments the system presents to the player a larger 2-D representation of the player's cards and chips at the bottom of the screen that the player can interact with in order to manipulate the 3-D representation of the player's cards and chips. As the player sends inputs to the user interface, the system could interpret the player's inputs to influence the 2-D and 3-D representations of the player's avatar and the player's game elements. As the user provides emotional inputs to the 2-D user interface, the system translates those inputs into an emotional profile that is then translated into movements of the 3-D poker cards and chips. Because the system maps the virtualized 3-D poker object elements onto the 2-D user interface, the 2-D user interface could be used to manipulate the 3-D poker object elements similarly to how the user might manipulate actual 3-D poker cards and chips.

If the player is using a touch screen device, for example, the player could touch a 2-D representation of the cards, which would be registered as the player touching and holding the cards. The system could then interpret this input into a gradual spectrum of the 3-D representation of the player's cards slowly being lifted towards the player across a spectrum to reveal the cards to the player. At a beginning of the spectrum (e.g., within the first second of touching) only the top left-hand corners of the cards might be lifted towards the player, in a middle of the spectrum (e.g., between the first second of touching and the third second of touching) the top-left hand corners and the middle of the cards could be lifted towards the player, and at the end of the spectrum (e.g., after three seconds of touching the 2D cards) the cards could be fully revealed to the player. On the other user interfaces, the opponents could also see a spectrum of the 3-D cards being revealed slowly more and more to the player over time, but facing away from the opponents and towards the player. When the player lets go of the 2-D representation of the cards, the 3-D representation of the cards could then be released and fall face-down on the table in both the player's user interface, and in the opponent's user interface.

The system could also gather other emotional inputs from the player while the player touches the cards. For instance, if the player's hand shakes from nervousness, the 3-D representation in both the player's and the opponent's user interface could shake according to the player's hand movements. If the player's heart rate increases, an avatar of the player could have a sweat drop appear on the forehead of the player's avatar. A plurality of emotional inputs could be translated into the user interface of the player, and/or the user interface of opponents watching the player's elements (e.g., the player's cards or the player's chips), the player's avatar, or other non-game elements of the player (e.g., a totem placed next to the player). Preferably, the 3-D representations of the player's cards or chips reflect inputs in real-time that the player provides with respect to the 2-D representations of the cards or chips. So when the player sends inputs to touch and drag one or more chips from a chip stack to a staging area of the 2-D representation, the 3-D representation of the chips in the player's user interface are dragged to the staging area of the 3-D representation. Or when the player touches and drags cards away from the origin point of the cards in the 2-D representation, the 3-D representation of the cards is dragged away and is sent to a muck pile in both the player's user interface and the opponent's user interface.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic of a software architecture embodiment.

FIG. 2 is a schematic of a real-time motion module.

FIG. 3 is a schematic of an input parsing logic for an interaction reviewer.

FIG. 4 is a flowchart of a method of handling real-time motion inputs for an embodiment.

FIG. 5 shows complete folding motions that could be captured and represented by an embodiment of a real-time motion module.

FIG. 6 shows incomplete folding motions that could be captured and represented by an embodiment of a real-time motion module.

FIG. 7 shows card viewing motions that could be captured and represented by an embodiment of a real-time motion module.

FIG. 8 shows card holding motions that could be captured and represented by an embodiment of a real-time motion module.

FIG. 9 shows betting motions that could be captured and represented by an embodiment of a real-time motion module.

FIG. 10 is a schematic of a biometric transformer module.

FIGS. 11A and 11B show flowcharts of methods of handling biometric information inputs for an embodiment of a biometric transformer.

FIG. 12 shows heartbeat biometric information that could be captured and represented by an embodiment of a biometric transformer.

FIG. 13 shows temperature biometric information that could be captured and represented by an embodiment of a biometric transformer module.

FIG. 14 shows facial expression biometric information that could be captured and represented by an embodiment of a biometric transformer.

FIG. 15 is a schematic of a staging area module.

FIG. 16 is a flowchart of a method of handling staging area inputs for an embodiment.

FIG. 17 shows betting pattern information that could be captured and represented by an embodiment of a staging area module.

FIG. 18 shows other betting pattern information that could be captured and represented by an embodiment of a staging area module.

FIG. 19 is a schematic of a UI dial module.

FIG. 20 is a state diagram of UI dial logic.

FIG. 21 shows bet information that could be captured and represented by an embodiment of a UI dial module.

FIG. 22 shows bet contemplation information that could be captured and represented by an embodiment of a UI dial module.

FIG. 23 shows chip exchange information that could be captured and represented by an embodiment of a UI dial module.

FIG. 24 is a schematic of a minigame module.

FIG. 25 is a flowchart of a method of handling minigame inputs for an embodiment.

FIG. 26 shows minigame information that could be captured and represented by an embodiment of a minigame module.

FIG. 27 shows other minigame information that could be captured and represented by an embodiment of a minigame module.

FIG. 28 is a hardware schematic of an embodiment.

FIGS. 29A and B are front and side orthographic views of a non-adjusted virtualized representation of a poker table.

FIG. 30 is a front perspective view of an adjusted virtualized representation of a poker table.

FIG. 31 shows a graphical representation of a player's user interface showing a 2-D and a 3-D graphical representation of some of the player's game elements.

### DETAILED DESCRIPTION OF THE INVENTION

Throughout the following discussion, numerous references will be made regarding servers, services, interfaces, engines, modules, clients, peers, portals, platforms, or other systems composed of computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash drive, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network.

The terms “configured to” and “programmed to” in the context of a processor refer to being programmed by a set of software instructions to perform a function or set of functions.

One should appreciate that the disclosed contacts directory discovery system provides numerous advantageous technical effects. For example, the contacts directory discovery system of some embodiments enables up-to-date contact information by methodically allowing the persons to update and edit contacts and contact information in shared directories.

The following discussion provides many example embodiments. Although each embodiment represents a single combination of components, this disclosure contemplates combinations of the disclosed components. Thus, for example, if one embodiment comprises components A, B, and C, and a second embodiment comprises components B and D, then the other remaining combinations of A, B, C, or D are included in this disclosure, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, numerical parameters expressing quantities are used. It is to be understood that such numerical parameters may not be exact, and are instead to be understood as being modified in some instances by the term “about.” Accordingly, in some embodiments, a numerical parameter is an approximation that can vary depending upon the desired properties sought to be obtained by a particular embodiment.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, ranges set forth herein should be interpreted as being inclusive of their endpoints and open-ended ranges should be interpreted to include only commercially practical values. The recitation of ranges of values herein is merely intended to serve as a shorthand method of referring individually to each separate value falling within the range. Unless otherwise indicated herein, each individual value within a range is incorporated into the specification as if it were individually recited herein. Similarly, all lists of values should be considered as inclusive of intermediate values unless the context indicates the contrary.

Methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the described concepts and does not pose a limitation on the scope of the disclosure. No language in the specification should be construed as indicating any non-claimed essential component.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### Overview

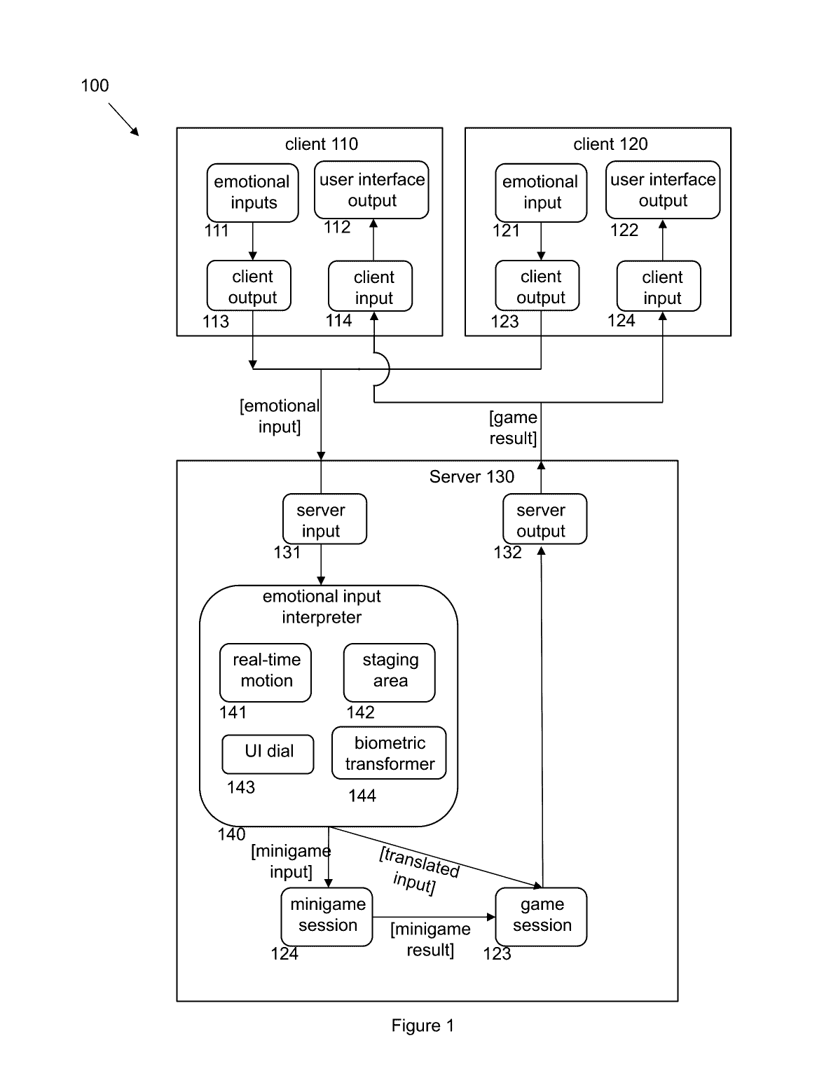

FIG. 1 shows a schematic of an exemplary software system 100. System 100 has a server module 130, which hosts one or more games between various client modules, and any number of clients that are playing games with one another. While system 100 only shows two client modules, client module 110 and client module 120, any number of client modules could be connected to server module 130 to play games. Typically each client module is configured to control the user interface of a single player, playing games using the system, although a client module could be configured to control a plurality of user interfaces for a plurality of players without departing from the scope of the invention. Each player typically has access to a single user interface through which system 130 could collect emotional inputs, and could provide user interface outputs through which a user could perceive elements of one or more game sessions hosted by server 130. As such, client module 110 has an emotional input module 111 that collects emotional inputs from a player, a client output module 113 that sends at least a portion of the emotional inputs to server 130, a client input module 114 that collects information from server 130, and a user interface output module 112 that transmits at least a portion of the client input received from server 130 to a user interface (not shown) that the player could interact with. Likewise, client module 120 has an emotional input module 121 that collects emotional inputs from a player, a client output module 123 that sends at least a portion of the emotional inputs to server 130, a client input module 124 that collects information from server 130, and a user interface output module 122 that transmits at least a portion of the client input received from server 130 to a user interface that the player could interact with.

As used herein, an “emotional input” comprises an input from a player user interface of the client module that could be analyzed and interpreted by system 130. Emotional inputs could be collected by user interface sensors that collect “conscious emotional inputs,” such as a keyboard that collects alphanumeric characters, a mouse or trackball that collects pointer position and clicks, a camera that collects a player's conscious movements, a microphone that collects a player's conscious speech, or a touch screen that collects movements of a player's digits on a screen. Emotional inputs could also be collected by user interface sensors that collect “unconscious emotional inputs,” such as a heartbeat monitor that collects a player's pulse, a camera that collects a player's unconscious eye movements or nervous ticks, a microphone that collects a player's unconscious noises, an accelerometer that collects a player's shaking hands, a force sensor that detects forces enacted by a player, or a thermometer that detects a player's temperature at some point of the player's body. All such emotional inputs could be sent to sever 130 via client output module for processing by the server, or the client could select a subset of the emotional inputs for transmitting. For example, a client module of a poker game might only wish to transmit emotional inputs from a touch screen, a camera, and an accelerometer to server 130, but not transmit emotional inputs from the microphone to server 130.

As used herein, a “user interface output” comprises an output to a player user interface of the client module that could be sent to a user interface to present game data to a player. User interface outputs could be transmitted to, for example, a screen or a touch screen that displays data to a player, a speaker that presents audio information to a player, a vibration motor that presents vibrating tactile information to a player, a Braille terminal that presents tactile information to a player, or a smelling screen that presents olfactory information to a player. In some embodiments, the user interface output module is connected to the same user interface as the emotional input module, such as a touch screen that both displays information to a player, and collects information from a player. The client input module is typically configured to interpret at least some instructions from server 130 to present information to a player via the user interface module.

Server 130 typically has a server input 131 that accepts information, such as emotional inputs, from one or more client modules, and a server output 132 that provides information, such as user interface outputs, to one or more client modules. Emotional inputs that are received by server input 131 are typically sent to an emotional input interpreter module 140, which interprets emotional inputs provided by the one or more clients, and translates those emotional inputs into various actions that are accepted by a game session for gameplay. The game session could be the main game being played and embodied by game session module 123, typically a poker game played between a plurality of client modules, or could be a minigame played only by the player and embodied by minigame session module 124, typically a minigame that the player could play on his/her own that has no simultaneous second player component. While emotional input interpreter module is shown here as being embodied on server 130, emotional input interpreter module could be embodied on any of the client modules, or could be distributed between client and server modules without departing from the scope of the current invention. An emotional input interpreter module implemented on a client is useful for predictive processing or input pre-processing that massages raw sensor data into more meaningful action data before it is sent to the server.

An emotional input interpreter module typically has several sub-modules that help parse specific types of emotional inputs and translate them into actions that the player takes for interacting with game session module 123 or minigame session module 124. Real-time motion module 141 typically accepts both conscious and unconscious emotional inputs and translates the emotional inputs into real-time motions that could be reflected by game session module 123, for example by causing a player's avatar to look at cards when the player taps cards on a user interface to look at them. Biometric transformer module 144 typically accepts unconscious emotional inputs and also translates the emotional inputs into motions that could be reflected by game session module 123, for example by causing a player's avatar to sweat when the player's heartbeat rises. Staging area module 142 typically accepts conscious emotional inputs specific to the staging area of the game, where players commit to actions, that could be reflected by game session module 123, for example by causing a player's avatar to bet chips when a player drags chips to the staging area of the game. UI (user interface) dial module 143 typically accepts conscious emotional inputs specific to a UI dial, where players count chips, that could be reflected by game session module 123, for example by causing a player's avatar to adjust a number of chips in front of the player when the player counts a certain number of chips. The emotional inputs are typically translated by one or more modules of emotional input interpreter module, and are then sent to game session module 123, or are then sent to minigame session module 124, to influence aspects of the game session. Results of the minigame could also be sent to game session module 123 to influence aspects of the game session.

Game session module 123 accepts the translated input from emotional input interpreter module 140, and uses the translated inputs to affect gameplay. Some of the translated inputs could be used to substantively affect gameplay, for example by causing a player of a poker game to call a hand, fold a hand, or bet. Other translated inputs could be used to non-substantively affect gameplay, for example by causing a user's avatar to perform an action like counting chips or looking at his/her cards. The changes to the gameplay could then be sent to server output 132, which then pushes the changes eventually to user interfaces of one or more of the client modules so that players could determine how the emotional inputs have affected the game session. Each of the modules of emotional input interpreter module 140 translates emotional inputs in different ways, as is explained below.

### Real-Time Motion Module

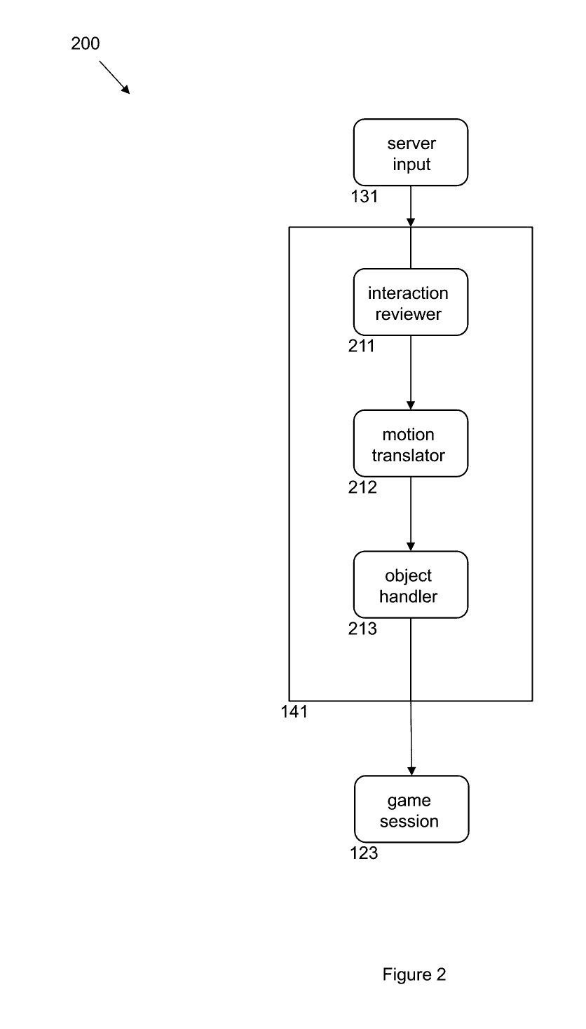

FIG. 2 is a schematic 200 of the exemplary real-time motion module 141 shown in FIG. 1. Real time motion module 141 accepts emotional input via server input 131, translates the emotional input, and provides translated interpretations of that emotional input to game session module 123 and/or minigame session module 124. The emotional input received from server input 131 is first received by interaction reviewer 211 of real time motion module 141. Interaction reviewer 211 receives an input that corresponds to a contemplated interaction with a player's user interface. As used herein, a “contemplated interaction” is an input received from a player that could substantively affect the same session if the contemplated interaction is completed. For example, a contemplated interaction might be a bet of $1,500 in chips. A player might count out $1,500 in chips, and might set forth those chips in front of the player on a virtual table. However, until that player moves those chips forward into a staging area to bet the chips, the contemplated interaction has not been completed. Before that time, the player may then pull those chips back and check or fold instead. While the player contemplated making the bet, the full sequence of events needed to complete the contemplated interaction of betting was not completed, and hence the steps taken by the player is insufficient to complete the contemplated interaction. Such insufficient inputs do not substantively affect the game session. Compare this against a completed contemplated interaction with an element of the user interface, which must substantively affect the game session, such as complete instructions to bet $1,500 in chips or to fold the player's cards.

Interaction reviewer 211 will receive emotional input from server input 131, and analyze the emotional input to determine if any of the received emotional input (e.g., a player's motions received from a touch screen, a player's eye movements caught by a camera) could be translated into a motion recognizable by the system. If interaction reviewer 211 recognizes any of the received emotional input as valid motions that could be translated into a motion, the recognized emotional input is then passed to motion translator module 212, which translates the recognized emotional input into a translated game motion. The translated game motion is then sent to object handler 213, which acts to give instructions to objects in game session 123. For example, if a player makes a contemplated interaction to bet $1,500 in chips, interaction reviewer 211 would recognize the contemplated interaction of swiping $1,500 in chips up to a staging area as a recognized motion, motion translator module 212 could translate that interaction into a motion to place $1,500 in chips in front of the avatar, and object handler module 213 might send instructions to game session 123 to display a player placing $1,500 in chips in front of his avatar. Then, if the player makes a contemplated interaction to pull the chips back and check instead, interaction reviewer 211 would recognize the contemplated interaction of swiping $1,500 in chips back towards the player's chips as a recognized motion, motion translator module 212 might translate that motion into a motion to pull the chips back, and object handler module 213 might send instructions to game session 123 to display an avatar pulling his chips back into his pile.

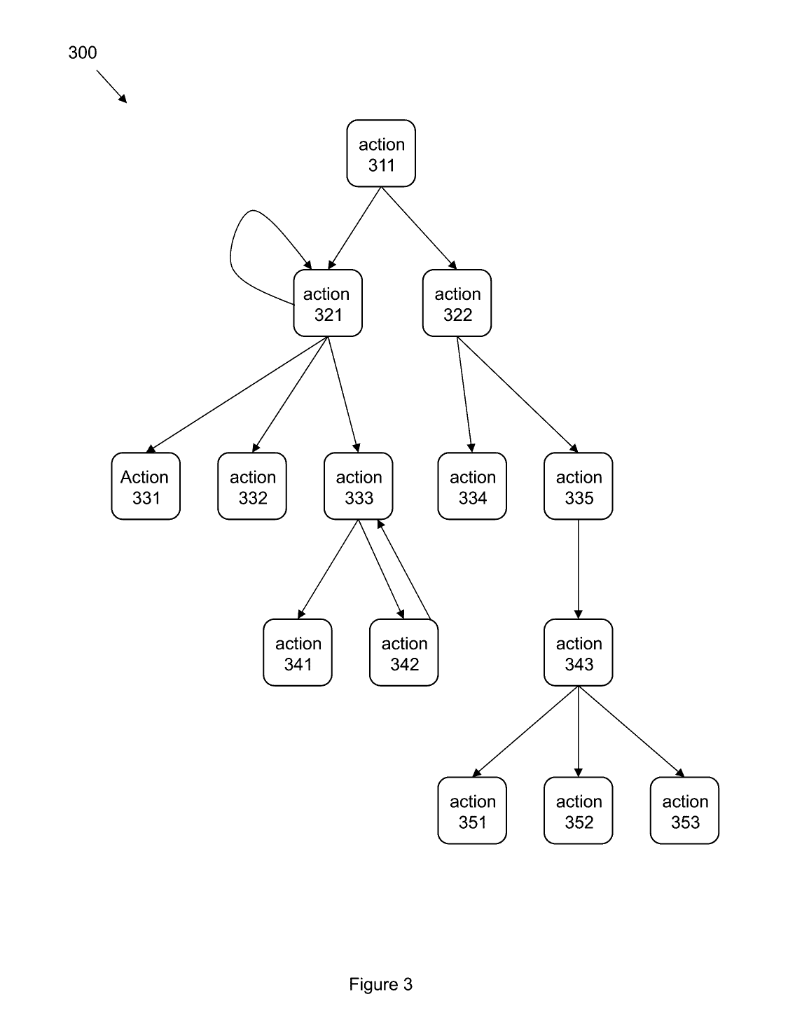

Interaction reviewer 211 typically uses one or more input parsing logic trees in order to determine whether an emotional input is a recognized emotional input that is translatable into a motion for the present game session. FIG. 3 shows an exemplary input parsing logic tree 300 that has the interaction reviewer first look for action 311 in the first level of logic tree 300. Once action 311 is detected, the action could be translated into a motion that is sent to the game session 123 (although not all recognized motions are necessarily translated). After action 311 is recognized, the interaction reviewer looks for action 321 or action 322 in the second level of logic tree 300. For example, action 311 could be a swipe to bring chips out to the front of the player to count before betting. Action 321 could be a swipe to bring additional chips out to the front of the player, while action 322 could be a swipe to bring the exposed chips back to the player's stacked piles of chips. Each consecutive action in the tree triggers the interaction reviewer to look for a different set of emotional inputs, typically on a lower level of logic tree 300. Thus, in order for an interaction reviewer to look for action 351 in the fifth level of logic tree 300, the interaction reviewer must first receive action 311, action 322, action 335, and action 343, in that order.

Input parsing logic trees do not need to necessarily be binary, ternary, or have any specific number of branches. Some actions lead to former levels in the logic tree, like for instance when a player performs action 333 after performing action 342, and other actions lead to the same action, like for instance when a player performs action 321 twice, three times, or four times in a row before then performing action 331, action 332, or action 333. When the system navigates to a leaf of the tree structure, the contemplated interaction is said to be completed, which permanently changes the state of the game. At any point, a user could perform a cancelling action (not shown) that would exit the logic tree and abandon the contemplated interaction, resetting the game status to the state the game was in before the first action was initiated.

In some embodiments, each action in the logic tree could be assigned to a graphical representation of the action. For example, if the series of actions to fold cards required a user to (1) touch the cards on the screen, (2) push the cards forward without releasing the screen, (3) push the cards towards the center of the staging area, and (4) release the cards by moving the finger away from the screen, each of the actions could be assigned to a graphical representation. In the above-mentioned example, the input of touching the cards could be assigned to a graphical representation of the player's avatar picking up the cards, the input of pushing the cards forward could be assigned to a graphical representation of the player's avatar extending an arm forward towards the table, the input of pushing the cards towards the center of the staging area could be assigned to a graphical representation of the player's avatar standing up slightly and reaching forward, and the input of releasing the screen could be assigned to a graphical representation of the player's avatar letting go of the cards. At any time, the player could exit the progression by moving his finger to an area outside of the staging area and releasing the screen.

Some input parsing logic trees consider inactivity from a player for a certain threshold of time (e.g., 5 seconds, 30 seconds, 60 seconds) as being an action. Typically, inactivity from a player above a certain threshold of time will trigger a warning user interface to be sent to the player, or will trigger an automatic “end of turn” command from the player. The warning user interface could also be assigned a graphical action, for example the user interface could show a floor manager tapping the shoulder of the player and talking to him. At this point, the logic tree could wait either for an action from the player (initiating a different contemplated interaction logic tree), a request for more time (initiating a new timer and possibly triggering a graphical display of a user pointing at a watch and the floor manager retreating), or a time delay of further inactivity (ending the player's turn and possibly triggering.

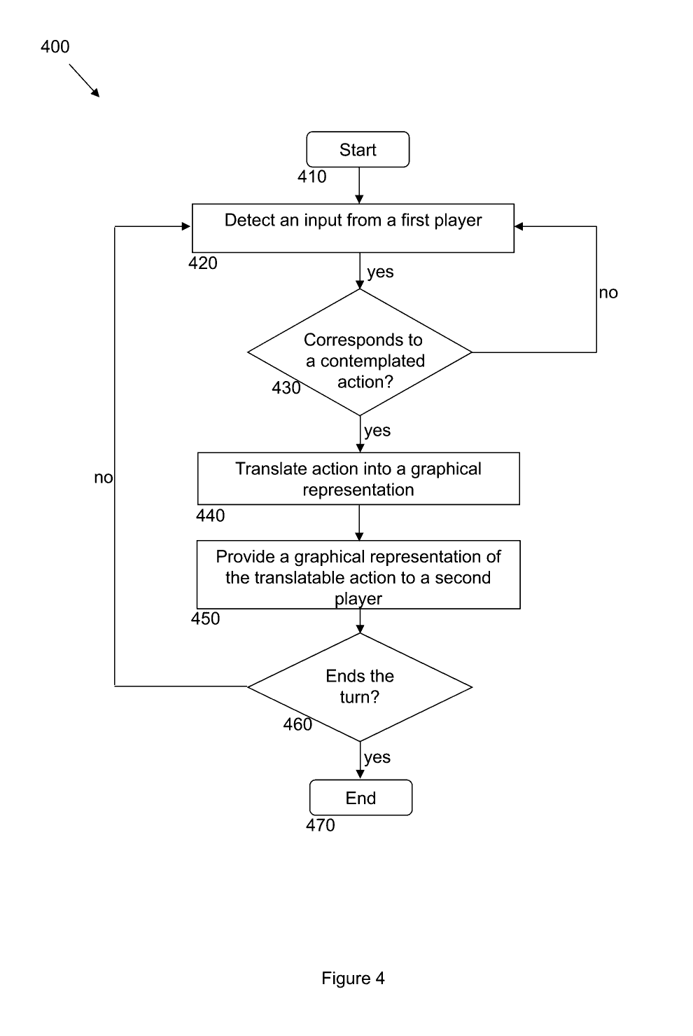

FIG. 4 shows a flowchart of an exemplary method 400 for handling real-time motion inputs to a real time motion module, such as real time motion module 141. At step 410, the player's turn starts, and emotional inputs received from the player's client module are received by the system at 420. Such emotional input could be completed, substantive contemplated interactions with elements of a user interface, or could be insufficient, non-substantive contemplated interactions with elements of the user interface (e.g., partial interactions that are insufficient to complete a substantive interaction). Contemplated interactions with user interface elements include revealing a hand of cards, calling a bet, checking a bet, placing a bet, going all-in, moving a card, folding a hand of cards, and folding. Each of these contemplated interactions affect the game substantively, altering the game in some way by placing the cards in a different location, or by committing a player's chips. Frequently, a substantive interaction will end that player's turn. Many of these contemplated interactions might be abandoned part-way through, yet could be translated into a graphical representation by the real time motion module 141.

At step 430, the system analyzes the emotional input to determine if the emotional input corresponds to a translatable action (e.g., corresponds to an action the system is waiting for in accordance with an input logic tree). Typically such actions are interactions between the player and a user interface element, such as an interactive object in a poker game (e.g., poker chips, the cards dealt to the player). If the emotional input does not correspond to a translatable action, the system goes back to step 420 and waits for a new input from the player. If the emotional input does correspond to a translatable action, the system translates the action into a graphical representation at step 440, and provides the graphical representation of the translatable action to at least one of the opponents at the table at step 450. Typically this is provided by sending an instruction to an object handler of the game session to alter the graphical representation of the game session, which is then reflected on the screen of the opponents.

Preferably, the graphical representations are presented in real-time with respect to receiving the emotional input from the client module. As used herein, “real-time” means within at most 5 seconds of receiving the emotional input, and is more preferably within 1 second, within 0.5 seconds, within 0.1 seconds, or within 0.05 seconds of receiving the emotional input. This way, opponents at the table could see the player's actions as the player is deciding what to do. The graphical representation could comprise an animation, such as a movement of chips in front of the player's avatar, or a movement of cards towards the center of the table (as if to fold the hand).

If the translatable action ends the turn of the player (e.g., the contemplated interaction is completed in a way to substantively affect the game session), the system could move to step 470, ending that player's turn and moving on to an opponent's turn at the table. Otherwise, if the translatable action does not end the turn of the player (e.g., the input is insufficient to complete the contemplated interaction), the system moves to step 420 to detect the next input from the player.

Emotional inputs received by the real time motion module could comprise a value measured along one or more spectrums. Typically, the location of the value on the spectrum dictates the type of movement that the emotional input is translated into. For example, the value along the spectrum could represent an extent to which the input contributes to completing the contemplated interaction, where 0 represents minimal movement, and 100 represents a full commitment. A value below 20 could be translated into a graphical representation of no movement by the player, a value between 20-80 could be translated into a graphical representation of a partial movement by the player, and a value between 80-100 could be translated into a graphical representation of a completed contemplated interaction by the player.

The graphical representation that is presented by the real time motion module, typically shown on opponent's user interfaces, could comprise a dynamic element that is changeable along a second spectrum different from the first spectrum. The dynamic element could have a value that is proportional to the value of the input. For example, if a user touches his cards, and then swipes upwards as if to fold, the center of the table could represent a 100 value, while the origin of the cards could represent a 0 value on a first spectrum. The graphical representation could then be a dynamic element of the player's avatar holding the cards as if to fold at a 0 value, and tossing the cards into the center of the table at a 100 value. The graphical representation of the player could alter from 0 to 100 on a second spectrum as the graphical representation of the player's arm is fully bent or fully straightened, in accordance with the value of the dynamic element along the second spectrum. Typically, (a) the user interface element that is manipulated by the player's actions in the player's user interface and (b) the user interface element that is the translated graphical representation by the real-time motion module in the opponent's user interface, both correspond to the same object in the poker game. For instance, in the folding example, both user interface elements correspond to the player's cards.

Contemplated spectrums for a player's input include a force of the player (e.g., a direction and a velocity vector of a movement of the player, or even an acceleration of a movement of a player), a pressure (e.g., how hard the player is pressing on an input sensor), a direction, a distance, a time period (e.g., how long the player has performed an action), a velocity, and an acceleration. The inventors expressly contemplate that velocity, acceleration, position, time, force, and pressure can be implemented in any embodiment requiring a player's input. Any description of an input that does not expressly include all possible input modes (e.g., the preceding list) application should be interpreted to impliedly contemplate all input modes described in this. Contemplated spectrums used by the system to create a graphical representation of the player's input include a color (e.g., the low part of the spectrum could be purple and a high part of the spectrum could be red), a length or distance, a brightness, a contrast, an opacity, or a speech bubble (e.g., the low part of the spectrum is a “ . . . ” and the high part of the spectrum is a “F#$@!” grumble) of a visual element in the user interface. Some elements could include sound, such as a noise the player is making, and the spectrum could range from a low to high pitch or have different types of sounds representing different points of the spectrum.

Contemplated emotional inputs comprise gestures by the player that are translated into motion and actions by the player's avatar in the game session. For example, the player's gesture could be one of many of a series of inputs that causes a hand of cards to be revealed as a function of the position of an appendage of the player (e.g., a hand, finger, or stylus of the player) and/or the amount of pressure applied by the player to a user interface input (e.g., a touch screen or a button). As the player moves his cards closer to the center of the table, the graphical representation of the player's cards are tilted more and more towards the opponents, closer to being revealed. Or a player could choose to show his cards to a player that is out of the game, revealing his cards to one or more opponents without folding his cards. And/or as the player pushes harder on a touch screen, the more the cards are tilted towards the opponents. Alternatively, the player's gesture could contribute to a series of inputs that causes a hand of cards to be revealed as a function of the position of an appendage of the player and/or a time since the player started the gesture. For instance, the real-time motion module could look for a player to tap the cards, and hold onto the cards for 5 seconds before folding. If the player taps and holds the cards for 3 seconds and lets go, the real-time motion module could provide a graphical representation of the player thinking about folding, but ultimately keeping the cards. If the player taps and holds the cards for 5 or more seconds before letting go, the real-time motion module could provide a graphical representation of the player's avatar folding. In other embodiments, the system could detect where cards are being dragged to on the user interface, and when the player drags the cards a threshold distance away from a point on the table (e.g., the center of the area where the cards originated on the table), the system could fold the cards and provide a graphical representation of the player folding. In other embodiments, a velocity sensor could detect the speed at which a player drags cards towards the center of the table or a force sensor could detect the acceleration of a player's movements. If the velocity or acceleration exceeds a certain threshold amount (e.g., 10 m/s or 5 m/ŝ2), the system could register such a movement as a fold and provide an appropriate graphical representation of the movement.

A player might also be able to swipe in a direction to provide a graphical representation of a specific direction. For example, if a player taps his cards and swipes 30 degrees to the left of the player's avatar and lets go, the graphical representation of the player could then fold the cards by throwing the cards into the center of the table at an angle of 30 degrees to the left of the player. In that situation, the graphical representation would show an indicator having a directional element oriented based on a direction derived from the gesture. The graphical representation of the player could also have an intensity element that is adjusted based on an intensity derived from the gesture. For example, if the player swipes towards the table within a certain time threshold (e.g., within half a second), the graphical representation of the player could violently fold, sending the player's cards flying. However, if the player swipes towards the table above the same time threshold, the graphical representation of the player could fold gently and set the cards down without much movement.

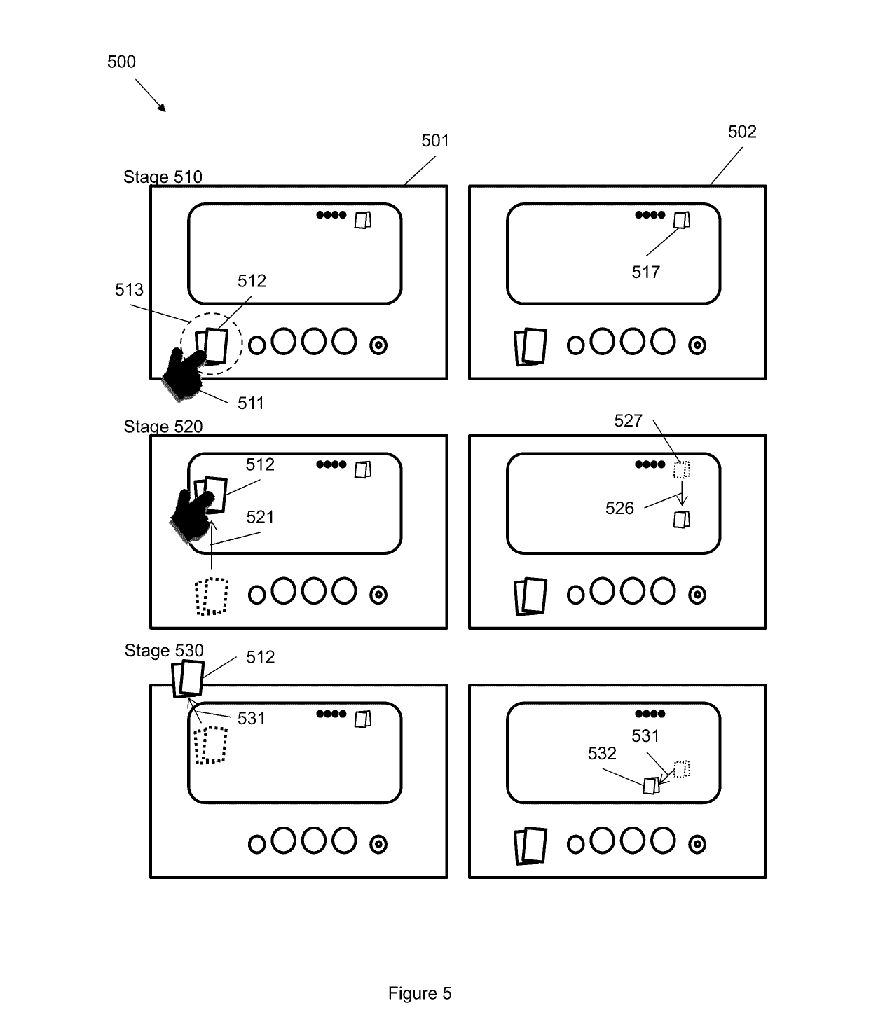

FIG. 5 shows an example 500 of various stages of a folding motion detected and translated by real time motion module 141. User interface 501 represents the user interface of Player A, whose emotional inputs are being monitored by the real time motion module 141, and user interface 502 represents the user interface of Player B, who receives graphical representations of the translated emotional inputs of Player A sent to game session 123 by real time motion module 141. In stage 510, Player A touches the cards in user interface 501, represented by black finger 511 on set of cards 512. The real time motion module 141 recognizes this as an action in the first level of a logic tree and waits for another action in the same logic tree. In some embodiments, this action is not translated into a graphical representation for player B, so no graphical representation of Player A touching the cards is represented in user interface 502. The system provides a range 513 around cards 512 within which a user's touches are detected for a user to be considered “touching” cards 512. In other words, when the user touches an area within range 513, the user is considered to be touching cards 512. Range 513 is shown here as a circle, but could be any shape, such as a square shape, or a shape of the cards.

Then, in stage 520, Player A swipes cards 512 towards the center of the table via swiping motion 521, representing a fold. The real time motion module 141 recognizes this as an action in the second level of the logic tree and translates swiping motion 521 into a graphical representation of Player A's cards 527 moving towards the center of the table via motion 526. While contemplated graphical representations of Player A's swiping motion 521 could be used, for example Player A's avatar could pick up cards 527 and slowly extend the arm holding the cards towards the center of the table as if to fold. In some embodiments, user interface 502 might not show cards 527 moving at all, and could instead show an arrow, such as arrow 526, that is displayed on the table. The arrow could be configured to change in size, transparency, and pointing direction to correspond with the distance from the initial card location, pressure on the screen, and direction of the cards relative to the initial card location on use interface 501, respectively. Such an arrow could be configured to not move beyond a certain threshold in radius away from the origin point in front of the graphical representation of Player A, so as not to overlap with other player's information. Such an arrow would give precise knowledge to remote user Player B on what Player A's finger is doing on user interface 501. In stage 530, Player A lets go of the cards while the cards are in the center of the table, and the game pulls the cards off of the table via motion 531. The real time motion module 141 recognizes this as an action in the third level of the logic tree, and folds Player A's cards. This translates into a graphical representation of Player A's cards being moved into the muck pile of cards 532 via motion 531. In some embodiments, Player A could be allowed to fold at any point (not only when it's Player A's turn) and the graphical representation of Player A folding could be configured to occur immediately when Player A completes the folding motion, or preferably when it is Player A's turn.

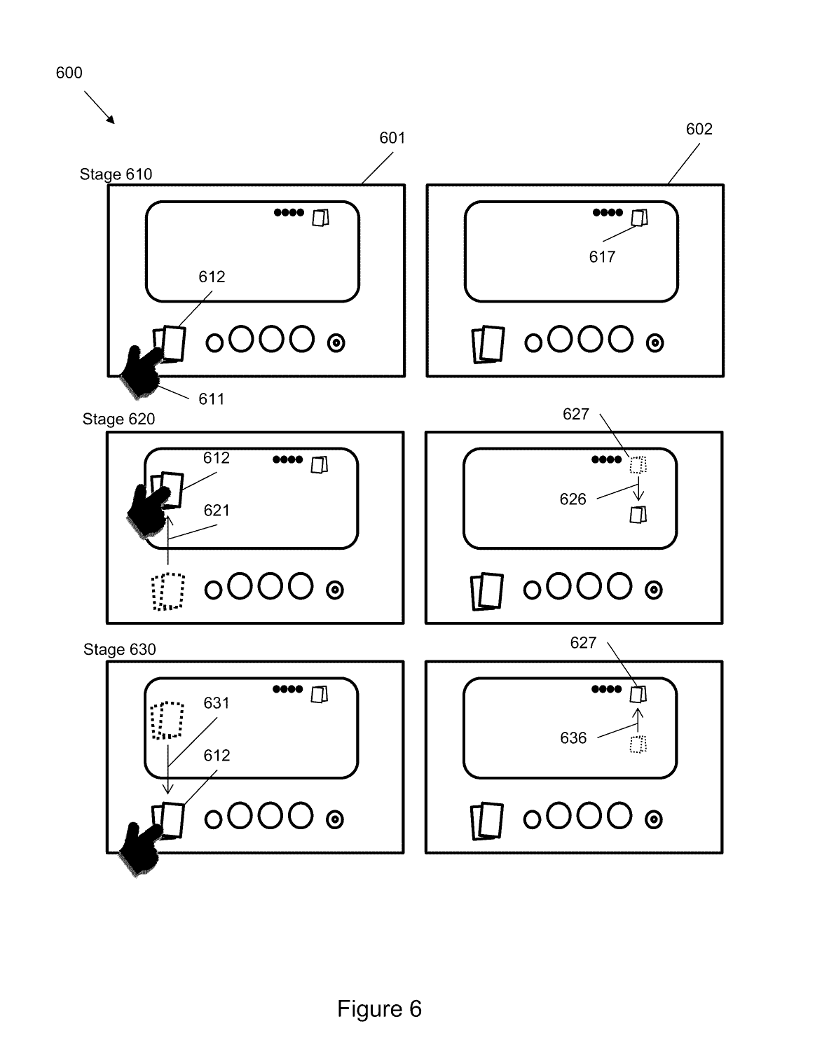

FIG. 6 shows an example 600 of various stages of an incomplete folding motion detected and translated by real time motion module 141. User interface 601 represents the user interface of Player A whose emotional inputs are being monitored by real time motion module 141 and user interface 602 represents the user interface of Player B who is receiving graphical representations of the translated emotional inputs. In stage 610, Player A touches set of cards 612, represented by a black finger 611 on set of cards 612. The real time motion module 141 recognizes this as an action in the first level of a logic tree and waits for another action. No graphical representation of Player A touching the set of cards 617 is represented in Player B's user interface 602 since Player A's finger has yet to move. Then, in stage 620, Player A swipes cards 612 towards the center of the table with swiping motion 621, representing a fold. The real time motion module 141 recognizes this as an action in the second level of the logic tree and translates this swiping motion into a graphical representation of Player A's cards 617 moving from their point of origin 627 towards the center of the table with motion 626. In stage 630, Player A pulls cards 612 back to their original position without letting go of the cards via swiping motion 631. The real time motion module 141 recognizes this as a cancelling action to abandon the contemplated interaction and resume play. In this situation, Player A's input corresponding to the contemplated interaction of folding the user interface element of cards 612 is insufficient to complete the action of folding. In user interface 630, game session 123 then moves Player A's cards 612 back to their original location via motion 631 and again waits for an input action from a first level of a logic tree. In user interface 627, game session 123 moves the graphical representation of Player A's cards 627 back to their original position as well via motion 636.

In some embodiments, user interfaces 601 and 602 do not show cards 627 actually moving as Player A drags the cards away from the card's point of origin. Instead, the user interfaces could show an arrow pointing away from the cards. The size and direction of the arrow displayed by the user interfaces could be calculated by the system as a function of the distance and direction, respectively, that Player A's finger has traveled from a point of origin (e.g., the point where the player initially touched the cards or the center of the cards). As Player A moves the finger away from the cards and towards the cards, the displayed arrow could get larger and smaller, respectively. As Player A moves the finger from left to right, the displayed arrow could also be moved from left to right. The displayed arrow in user interface 602 will typically be a mirror image from the displayed arrow in user interface 601. In some embodiments, the size of the arrow will be capped at a certain size, so when the user moves the finger beyond a threshold distance, the arrow size will not increase past that size. When the user moves the finger beyond the threshold distance, a different metric could be used to represent the distance that the finger moves from the origin, such as an opacity of the arrow. (e.g., the arrow could be faint and fairly transparent when the user's finger is close to the point of origin, and the arrow could be darker the further the user's finger is from the point of origin)

The system could be configured to perform a variety of tasks based upon where Player A's finger is when Player A releases cards 612. Where the user lets go of cards 612 within a first threshold distance of the origin of where cards 612 are originally placed, the system could provide a graphical representation of cards 612 being set back down on the table in front of Player A's avatar. Where the user lets go of cards 612 outside the first threshold distance of the origin but within a second threshold distance of the origin, the system could provide a graphical representation of cards 612 being tossed into a muck pile. Where the user lets go of cards 612 outside the second threshold distance of the origin, the system could provide a graphical representation of cards 612 being rapidly thrown into the muck pile and flying off of the table. In other embodiments, where the user lets go of cards 612 outside the first threshold distance of the origin, cards 612 will move towards the location where Player A released the finger with a velocity that corresponds with the speed and direction that the finger was released with respect with the origin. By making a card toss a function of gesture velocity (e.g., velocity of a finger input on a touch screen), the card toss itself becomes a function of at least time, speed, and direction. After Player A releases the finger, the system could cause the arrow to slowly fade away from user interface 602, and the system could also provide a representation of the cards gradually fading away into the muck area. Other ways of representing the user's intent to fold cards 612 could be used.

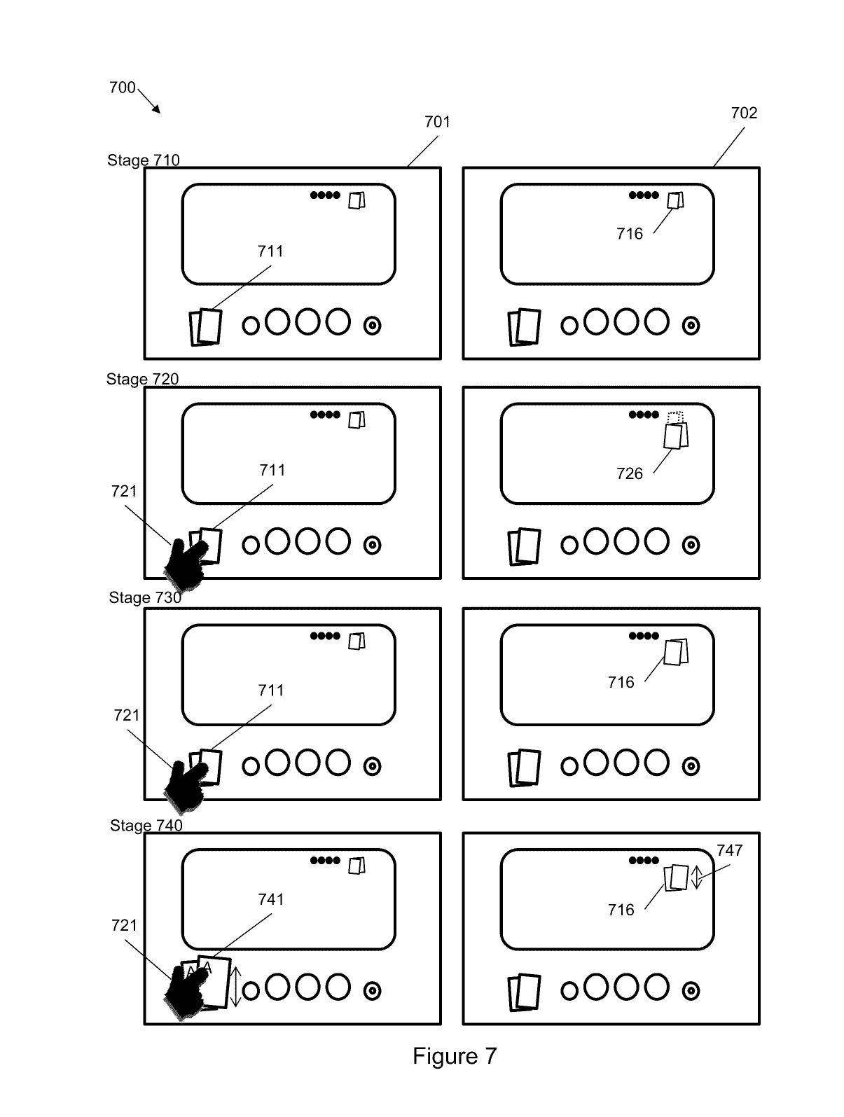

FIG. 7 shows an example 700 of various stages of a card reading motion detected and translated by real time motion module 141. User interface 701 represents the user interface of Player A, whose emotional inputs are being monitored by real time motion module 141 and user interface 702 represents the user interface of Player B, an opponent who is receiving graphical representations of the translated emotional inputs. During stage 710, Player A and Player B in both user interfaces. In user interface 701, Player A has a set of cards 711, and in user interface 702, Player A's set of cards 716 is shown graphically represented to Player B. In stage 720, Player A taps and holds set of cards 711, represented by black finger 721. While the set of cards 711 remain in the same place in user interface 720, real-time motion module 141 translates the tapping and holding motion of Player A into a shifting of Player A's cards. This translated motion is shown in a graphical representation in user interface 702, as Player A's cards are slightly shifted forward to position 726, indicating to Player B that Player A is contemplating doing something with the cards. At stage 730, Player A continues to hold cards 711 by keeping the finger held down. Both user interface 701 and 702 remain the same as they looked at the end of stage 720—the set of cards 711 in user interface 701 remain in the same place while the set of cards 716 in user interface 702 are moved to position 726. At stage 740, Player A continues to hold set of cards 711 beyond the threshold period of time of at least 3 seconds, and the real time motion module recognizes, that since Player A has tapped and held the cards down for a threshold count of at least 3 seconds, Player A wishes to view the set of cards 711. In user interface 701, the real time motion module sends an instruction to game session 123 to allow Player A to view the set of cards 711 as revealed cards 741. In user interface 702, real time motion module 141 translates the motion of holding cards for more than 3 seconds, and sends an instruction to game session 123 to indicate to Player B in user interface 702 that Player A is looking at his cards by shaking the set of cards 716 in up and down motion 747. In alternative embodiments, cards 716 could be slightly folded up and away from Player B and towards an avatar of Player A. Typically, this will last as long as Player holds down cards 711. When Player A lets go of the cards, the cards will return back to their original state in both user interfaces.

In some embodiments, as soon as Player A starts touching cards 711, user interface 702 could display Player A's cards 716 tilting in a spectrum towards Player A and away from Player B, while user interface 701 could display Player A's cards 721 as revealed to Player A. Such a motion detection and graphical representation translation could be configured to occur whether or not it is Player A's turn. The longer Player A's finger is held on cards 711, the more tilted the graphical representation of cards 716 would be towards the avatar of Player A, until the tilted cards hit a maximum threshold tilt (e.g., when the cards are shown in a full plan-view in front of Player A). When Player A releases the finger, the system could then recognize this input and the remote cards 716 could be configured to animate down in a spectrum until remote cards 716 are laying back down on the table in both user interface 701 and in user interface 702. In this embodiment, Player B would need to pay close attention to know that Player A looked at the cards, because the cards would animate up and immediately animate down without tilting completely upright in user interface 702. This distinguishes new players from experienced players, since pros seldom look at their cords twice, and if they do, they frequently only look at their cards for a short amount of time, allowing Player B to judge the experience level of a player by observing how the player acts. In some embodiments, while Player A touches cards 711, slight movements of Player A's finger could be registered to move cards 711 around on the table, which Player B could notice in user interface 702. When Player A lets go of cards 711, the cards could be placed face-down on the table as a function of how much Player A's finger moved while Player A was touching cards 711. Thus, an astute Player B might be able to notice whether or not Player A looked at the cards, even if Player B did not actually see Player A's cards tilt up, by noticing if Player A's cards moved slightly from their point of origin.

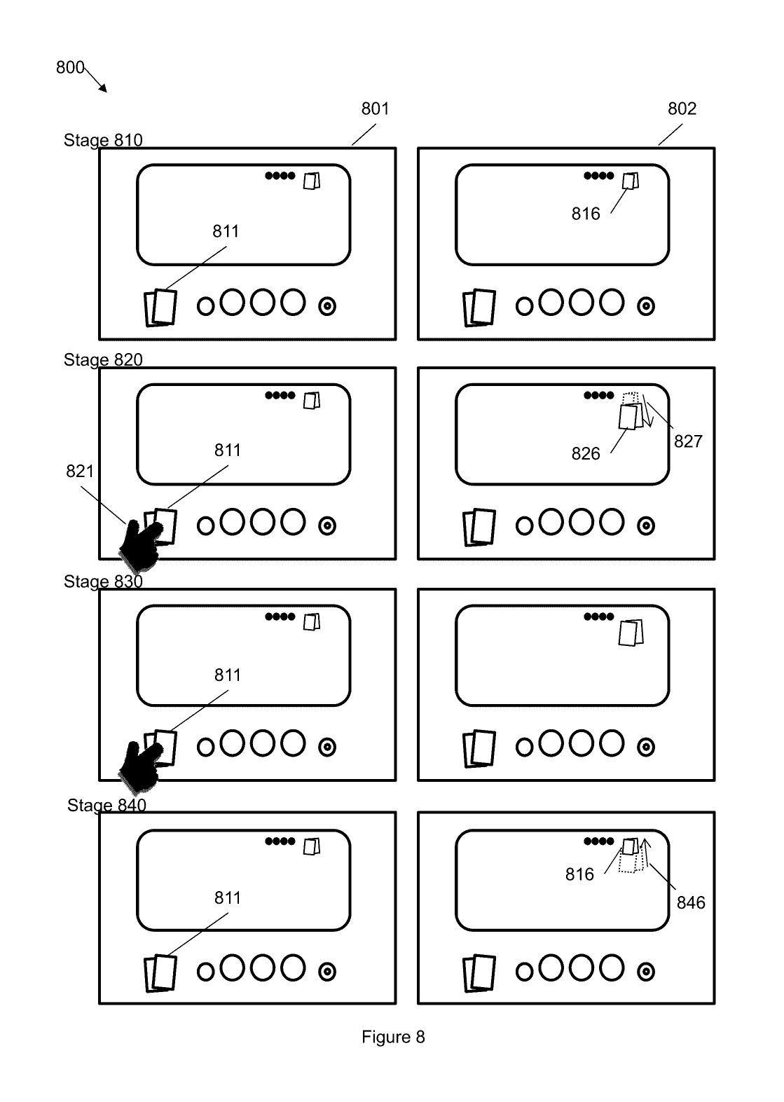

FIG. 8 shows an example 800 of various stages of an incomplete card reading motion detected and translated by real time motion module 141. User interface 801 represents the user interface of Player A, whose emotional inputs are being monitored by real time motion module 141, and user interface 802 represents the user interface of Player B, who is receiving graphical representations of the translated emotional inputs of Player A. During stage 810, Player A and Player B both have their cards dealt to them in both user interface 801 and user interface 802. Player A's cards are shown as set of cards 811 in user interface 801 and as set of cards 816 in user interface 802. During stage 820, Player A taps and holds onto set of cards 811, represented by the black finger 821. In user interface 801, the status of the set of cards 811 does not change. However, in user interface 802, game session 123 shows set of cards 816 as moving slightly forward to new position 826 via movement 827, indicating that Player A is contemplating doing something with the cards. At stage 830, Player A continues to hold cards 811 down for a time period below the threshold count of 3 seconds. Both user interfaces remain the same as they looked at the end of stage 820. At stage 840, Player A lets go of the set of cards 811, represented by the absence of a black finger, and lets go before the threshold count of 3 seconds. Real time motion module 141 recognizes that since the player has let go of the cards before the threshold count of 3 seconds, the player wishes not to view his cards and wishes to abandon this action sequence. In user interface 801, the set of cards 811 remain where they were during stage 830, and remain face-down. In user interface 802, real time motion module 141 sends an instruction to game session 123 to reset the position of cards 816 to their original spot, and card 816 slide back down to their original position via movement 846.

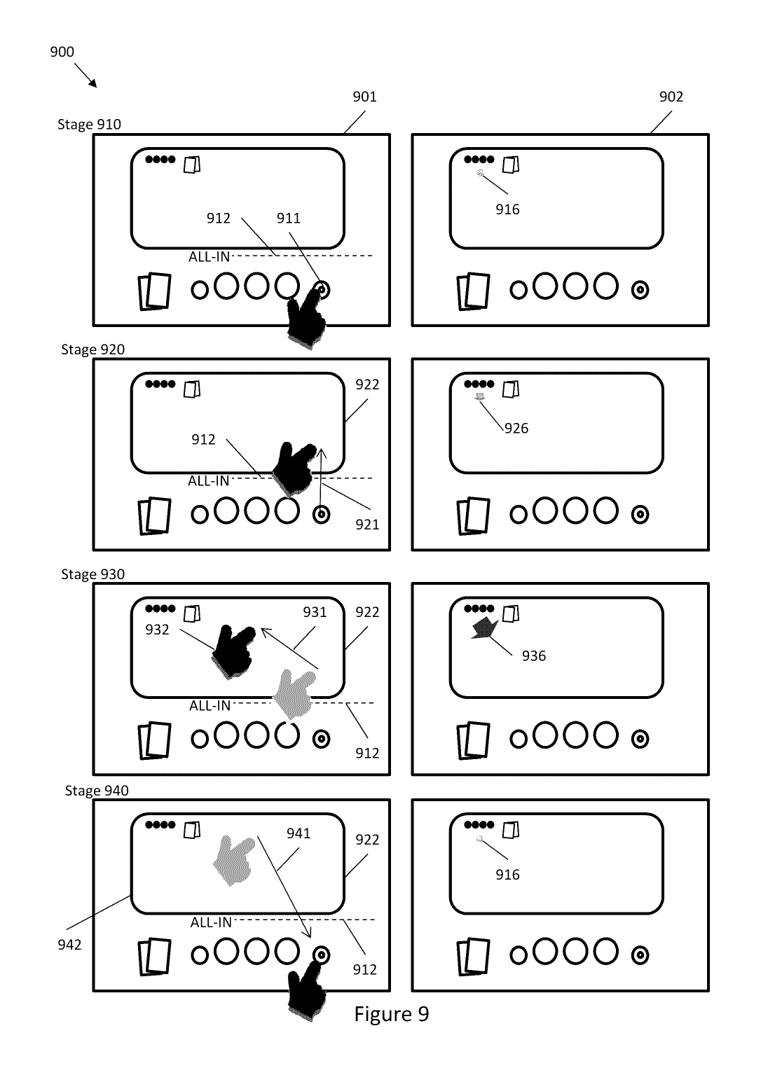

FIG. 9 shows an example 900 of various stages of an incomplete betting motion detected and translated by real time motion module 141. User interface 901 represents the user interface of Player A, whose emotional inputs are being monitored by real time motion module 141, and user interface 902 represents the user interface of Player B, who is receiving graphical representations of the translated emotional inputs. During stage 901, Player A taps and holds abet button 911 for a threshold number of seconds (e.g., 3 seconds), and real time motion module 141 recognizes this gesture and translates it into a graphical representation of Player A's dot 916 being activated in front of Player A's chip stack in user interface 902. This action also triggers game session 123 to recognize that Player A is considering an all-in, and draws ALL IN line 912 on Player A's user interface 901. In some embodiments, the graphical representation of dot 916 has a transparency level that changes as a function of the amount of pressure Player A applies to button 911 in user interface 901. Where Player A is gently pushing on button 911, dot 916 could have a high transparency level, and where Player A is pushing hard on button 911, dot 916 could have a low transparency level (i.e. highly opaque). In some embodiments, user interface 901 could provide a representation of the dot so that Player A has a representation of what Player B sees in Player B's user interface. During stage 920, Player A keeps the finger down and makes a swiping motion 921 up past ALL IN line 912 into the staging area 922, indicating a contemplated interaction of an all-in bet. Real time motion module 141 recognizes this action, and translates the action into small arrow 626 in user interface 902 stemming from the chips in front of Player A. Preferably the graphical representation of small arrow 626 is configured such that a size and direction of small arrow 626 is drawn as a function of the distance from button 911 and an angled direction from button 911, so Player B has a visual representation of Player A's movements. Generally, the system draws arrow 926 after Player A's finger has moved a threshold distance from an origin point of button 911 (e.g., the location where Player A first touched button 911, or the center of button 911).

During stage 930, Player A continues to touch the screen, and brings the finger towards a center area of the staging area 922 with swiping movement 931. Real time motion module 141 recognizes the action and represents the action as a much larger arrow 936, drawn larger since the distance of the finger 932 is greater and angled more since finger 932 is more towards the center of staging area 922. Arrow 936's size and direction is preferably drawn as a function of the distance and direction, respectively, of finger 932 from an origin point of button 911. In some embodiments, the system arrow 936 could have a threshold size such that when finger 932 travels to or beyond a threshold distance from the origin point of button 911, arrow 936 remains at the upper limit of its capped threshold size, so as not to take up too much screen real estate on user interface 902. In other embodiments, button 936 could change in transparency as a function of the distance that finger 932 is from the origin point of button 911, becoming darker the farther finger 932 is from button 911, and lighter the closer finger 932 is to button 911. During stage 940, Player A, still pushing down on the screen, brings the finger off staging area 922 without letting go, and back to the original bet button as motion 941, located below ALL-IN line 912. Real time motion module 141 recognizes the action as returning back to a previous state, and reflects this by pulling the chips back to their original position in user interface 902, and again shows button 916 in front of Player A's chip stack, indicating that Player A is still contemplating a bet. The system generally performs different actions depending upon where upon user interface 901 Player A's finger lets go of the screen. Where Player A lets go of the screen within a first threshold distance of an origin point of button 911, the system could exit the logic tree of an all-in bet and could wait for the next input from Player A. Where Player A lets go of the screen within center area 942, but within a second threshold distance of an origin point of button 911, the system could provide a graphical representation of all of the chips moving in a stack towards the center of the table. Where Player A lets go of the screen within center area 942, but outside the second threshold distance of the origin point of button 911, the system could provide a graphical representation of all the chips separately splashing towards the center of the table. In some embodiments, the chips could splash towards the center of the table as a function of the distance that finger 932 is from the origin point of button 911. Thus, when finger 932 is released close to button 911, the chips are splashed at a low velocity, whereas when finger 932 is released far from button 911, the chips are splashed at a great velocity. In other embodiments, the chips could splash towards the center of the table as a function of a velocity (e.g., direction and speed (where speed is a function of distance and time)) that finger 932 travels away from the origin point of button 911. In such an embodiment, when finger 932 travels at, for example, high speed, the chips are animated to splash toward the center (or in whatever direction is reflected by the velocity vector of finger 932) at a high speed. In some embodiments, the system could be configured to regroup the chips in an area in front of the player after they have been splashed. Other graphical representations of Player A's inputs are contemplated.

Biometric Translator

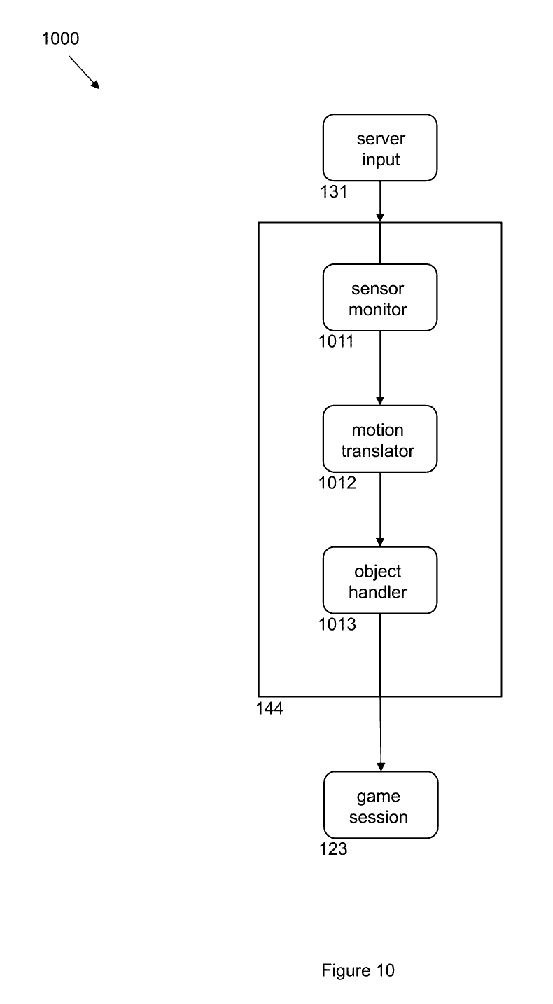

FIG. 10 is a schematic 1000 of the exemplary biometric transformer module 144 shown in FIG. 1. Biometric transformer module 144 accepts emotional input from server input 131, translates the emotional input, and provides translated interpretations of that emotional input to game session 123. The emotional input received from server input 131 is first received by sensor monitor 1011 of biometric transformer module 144. Typically, the emotional input received by sensor monitor 1011 comprises unconscious emotional inputs, such as a heartbeat monitor that collects a player's pulse, a camera that collects a player's unconscious eye movements or nervous ticks, a thermometer that detects a player's temperature at some point of the player's body, or a blood glucose meter that monitors a player's blood glucose level. Sensor monitor 1011 receives biometric input from a player and monitors the biometric input for changes that could be translated into a motion that could be used by the system to modify game session 123. For example, when a player's heartbeat switches from one threshold area to another threshold area (exemplary threshold areas could be, for example 60-80 bpm, 80-100 bpm, 100-120 bpm, and 120-140 bpm), sensor monitor 1011 could send the new heartbeat pulse to motion translator 1012, which translates the new heartbeat pulse into a new motion for game session 123. For example, the new motion could be an actual representation of the player's heartbeat, such as a visual heartbeat monitor or an audio beat, or the new motion could be a facial expression on an avatar of the player, such as a different color to the avatar's face or a number of sweat drops on the avatar's brow (a higher heartbeat expressed as a higher number of sweat drops). Motion translator 1012 then sends this motion to object handler 1013, which modifies an object in game session 123 to reflect the new transformed motion.

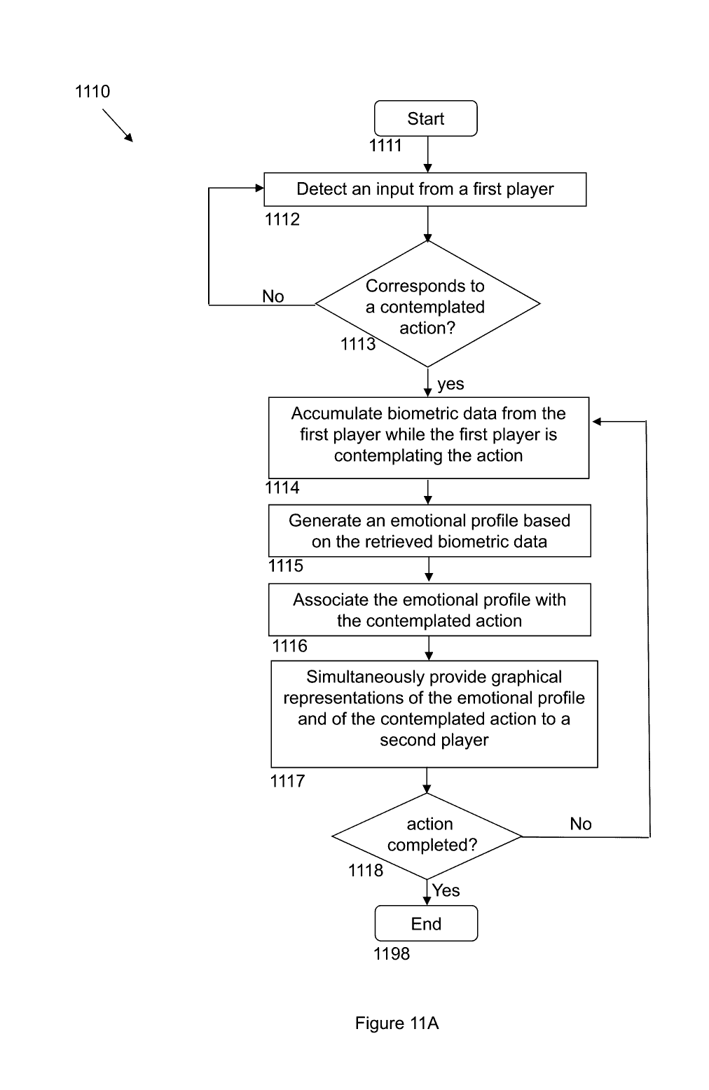

FIG. 11A shows a flowchart of an exemplary method 1110 for a biometric translator, such as biometric translator 144, to handle biometric inputs during a player's contemplated interaction. These steps tend to occur concurrently with the steps in flowchart 400, performed by the real time motion module. At step 1111, the system starts to detect inputs from the player. This generally occurs when it is the player's turn to act. At step 1112, the system detects an input from the player, and at step 1113, the system determines whether or not the input from the player corresponds to a contemplated interaction, typically by comparing the input against an input parsing logic tree, such as logic tree 300. If the input does not correspond to a known contemplated interaction, the system will return to step 1112, continuing to detect inputs from the player. If the input does correspond to a known contemplated interaction, the system starts to accumulate biometric data from the player while the player is contemplating the action in step 1114. Such biometric data could be collected in any suitable manner, for example by monitoring a heartbeat through a heartbeat monitor, monitoring the player's actions through a camera, or by monitoring the player's stability through an accelerometer. Such sensors could comprise a wearable electronic device, such as a wearable headset or glove that monitors a temperature, stability (i.e. how much the player shakes), a pulse/heart rate, a sweat level (i.e. how much the player sweats), a voice pattern (e.g., a microphone that detects a player's pitch, tone, exclamations), a gesture, eye movements, and/or a number of blinks of the player.

Whatever the biometric input, the biometric data is then used to generate an emotional profile based on the retrieved biometric data in step 1115. For example a player with a higher heartbeat and a higher sweat level (e.g., above a specified threshold than at the start of the player's turn) could have an emotional profile of a nervous player, whereas a player with a normal heartbeat and a normal sweat level (e.g., within a specified threshold as the start of the player's turn) could have an emotional profile of a calm player. Emotional profiles could also be constructed for players that lack biometric inputs. For example, if a player decides to remove a biometric sensor during play, the player could have a blank emotional profile, representing a non-responsive or a disconnected player. In step 1116, the biometric translator associates the emotional profile with the contemplated interaction. In step 1117, the biometric translator simultaneously provides graphical representations of the emotional profile and of the contemplated interaction to the opponent player. Such graphical representations could modify the graphical representation of the contemplated interaction, or could be presented in addition to the graphical representation of the contemplated interaction. For example, if a player with an emotional profile of a nervous player is counting chips, the player's avatar could be nervously counting the chips, shaking and sweating while doing so. Or if a player with a non-responsive profile is counting chips, the player's avatar could have X's over its eyes and be counting the chips with a limp, dead hand. In alternative embodiments, an additional icon or graphical interface could be displayed next to the player, such as a heartbeat pulse monitor or a color of a displayed face that reflects a state of nervousness.

In step 1118, the biometric translator determines whether or not the player has completed the contemplated interaction. If the player has completed the contemplated interaction, such as finishing a bet, the biometric translator proceeds to step 1119 and stops monitoring the player. If the player has not yet completed the contemplated interaction, the biometric translator returns back to step 1114 and continues to accumulate biometric data from the player.

FIG. 11B shows a flowchart of an exemplary method 1120 for a biometric translator 144 to handle biometric inputs throughout the entirety of game session 123. At step 1121 the game session 123 starts, and biometric translator 144 monitors the player's biometric inputs in step 1122. The biometric translator generally continues to do so throughout the game session 123. For each biometric input that is detected by the system, the system checks to see if the biometric input corresponds to a translatable action in step 1123. Some inputs could be translatable (e.g., if the heartbeat of a player passes a threshold barrier, or if the heartbeat of a player spikes or falls by changing by more than 5 or 10 bpm within a 3 or 5 second span), while other inputs could not be translatable (e.g., if the heartbeat of a player remains constant or if the eyes of a player move within the same designated area). If the system determines that the biometric input is not translatable, the system ignores that input and continues to detect biometric inputs at step 1122. If the biometric input does correspond to a translatable action, the system then modifies an emotional profile for the player based on the retrieved biometric data in step 1124, and then provides a graphical representation of the translatable action to the opponent in step 1125. Such graphical representations typically modify the player's avatar in some manner, such as adding sweat drops for a nervous player or making the player dance if the player bounces a few times within a specified time period. These graphical representations are displayed throughout the game, whether or not it is the player's move, and are typically presented alongside conscious, purposeful movements of the player (e.g., when the player looks at the cards or is contemplating folding the cards) or are used to modify the graphical representations of the player's movements. In step 1126, the biometric translator determines whether or not the game session 123 has ended. If the game session 123 has not ended, the module continues to detect biometric inputs in step 1122. If the game session 123 has ended, the biometric translator stops monitoring the player in step 1127.

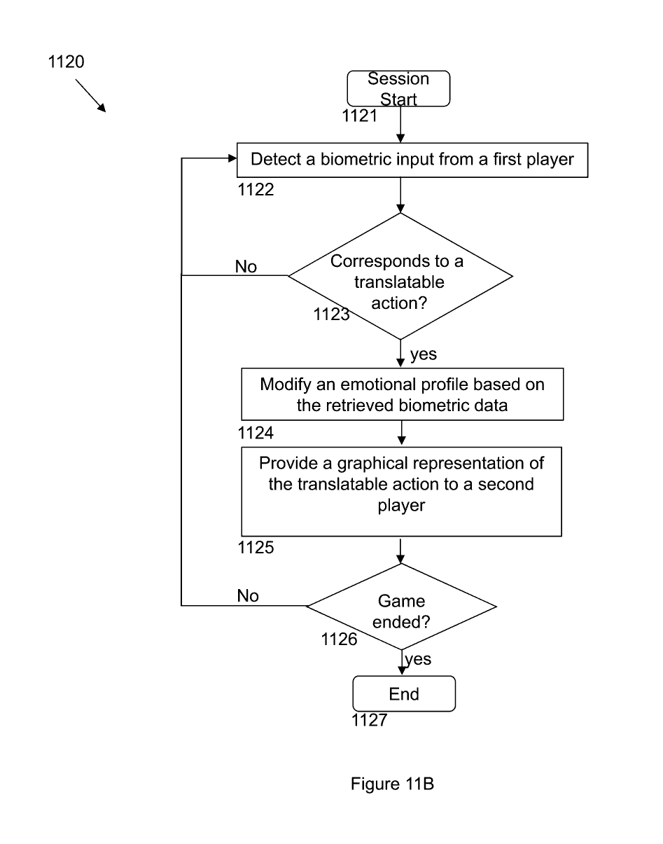

FIG. 12 shows an example 1200 of how biometric translator 144 might represent various stages of Player A, who is in the middle of contemplating a bet using a heart rate monitor. In stage 1210, the player is starting to contemplate a bet by touching the all-in betting button. At this point the biometric translator 144 starts to monitor Player A's biometric data and Player B's biometric data (or has always been monitoring the players' biometric data, but only now starts reporting the biometric data now that Player A is performing recognizable actions). User interface 1201 shows to Player A, Player B's heart rate 1211 at 60 and user interface 1202 shows Player B, Player A's heart rate 1216 at 60. In stage 1220, Player A starts to move his finger towards the staging area, and in user interface 1202, Player B sees Player A's chips start to move forward in an all-in motion. Both Player A and Player B's heart rate monitors show activity, and Player B's heart rate 1221 rises to 65 bpm while Player A's heart rate 1226 also raises to 65 bpm. In stage 1230, Player A starts to move the chips closer to the center of the table, and Player B sees the chips moving at a faster rate. In user interface 1201, Player A sees that Player B's heart rate 1231 remains steady at 65 bpm, but in user interface 1202, Player B sees that Player A's heart rate 1236 spikes at 75 bpm. In stage 1240, Player A pulls the bet back. In user interface 1201, Player A sees that Player B's heart rate 1241 has settled down to 60 bpm, and in user interface 1202, Player B sees that Player A's heart rate 1246 has gone down a bit to 65 bpm.

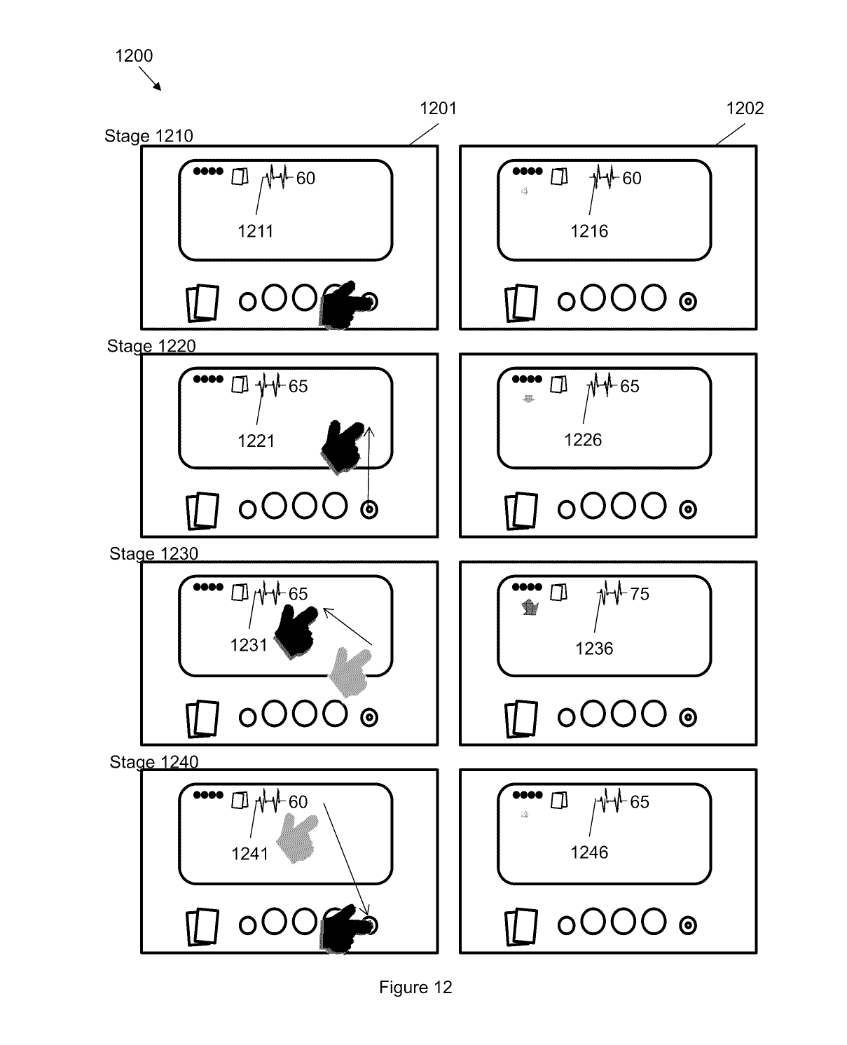

FIG. 13 shows an example 1300 of how biometric translator 144 might represent various stages of Player A, who is in the middle of contemplating a bet using a numerical nervousness scale. Such nervousness scales could be calculated as a function of a plurality of biometric inputs, such as both a heart rate and a moisture level (which represents how much that player sweats) of Player A. A simple example of such a nervousness scale formula would be to rate the heart rate and the moisture level of a player from a scale from 1-10, and to average the two to provide a nervousness scale result. In stage 1310, Player A again touches the all-in button to initiate a possible bet, and the numerical scales start to show for both Player A and Player B. Player B is shown having a nervousness scale 1311 of 4 in user interface 1301, whereas Player A is shown as having a nervousness scale 1316 of 5 in user interface 1302. In stage 1320, Player A starts to move the chips towards the staging area, and Player B's nervousness scale 1321 rises to 5, while Player A's nervousness scale 1326 stays steady at 4. In stage 1331, Player A moves the chips towards the center of the staging area, and Player B's nervousness scale 1331 stays at 5, whereas Player A's nervousness scale 1336 spikes to 8. Then in stage 1340, Player A moves the chips back off the staging area, and Player B's nervousness scale 1340 returns to 4, while Player A's nervousness scale 1346 lowers to 5.

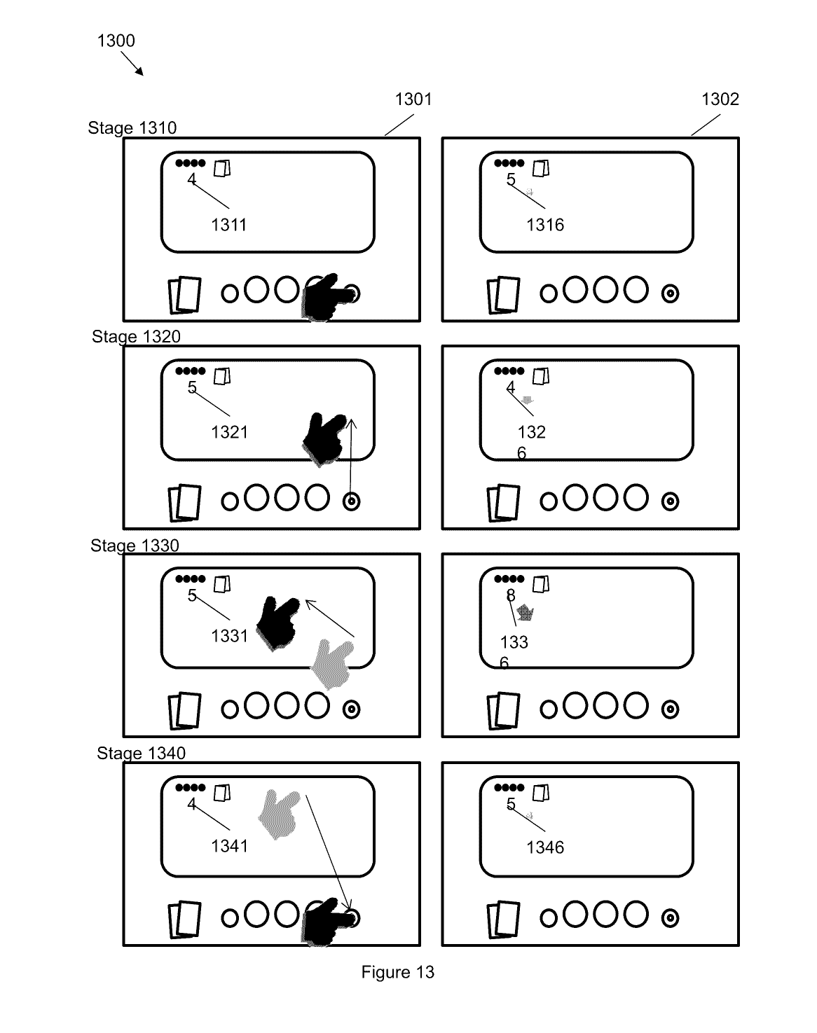

FIG. 14 shows an example 1400 of how biometric translator 144 might represent various stages of Player A, who is in the middle of contemplating a bet using a facial coloring scale for the player and Player B's avatar. Such a scale uses light colors for a confident user, and dark colors for a nervous user. In stage 1401, Player A starts to initiate a bet, and Player B's avatar 1411 is shown as being relatively dark (nervous) in user interface 1401, whereas Player A's avatar 1416 is shown as being relatively light (confident) in user interface 1402. As used herein, a “relative darkness” or “relative lightness” means a color that is lighter or darker than the average color of an avatar. Here, since the avatars have 5 levels of darkness, an avatar at a level 3 shade would be an average color, an avatar at a level 1 or 2 shade would be relatively light, and an avatar at a level 4 or 5 shade would be relatively dark. In stage 1420, Player A starts to move the chips towards the staging area, and Player B's avatar 1421 is shown as lightening to be a bit more confident, and Player A's avatar 1426 darkens to be a bit less confident. In stage 1430, Player A moves the chips closer to the center of the table, and Player B's avatar 1431 lightens to be even more confident, while Player A's avatar 1436 darkens to be much less confident. In stage 1440, Player A pulls the chips back, and Player B's avatar 1441 is shown as darkening to be less confident, while Player A's avatar 1446 stays dark to show that Player A is less confident.

Staging Area

During a traditional game of poker, a tell from a player could take the form of partially completed actions. For example, while contemplating a next move, a player could begin moving chips to the center of the table. The player could change her mind and move the chips back from the center of the table to the player's main chip stack without completing a move. For other players, observing this process can be strategically important. For example, a player's hesitation to place a bet, as evidenced by moving chips back from the center of the table, could be evidence that the player does not have a good hand. Preferably a graphical representation of the actions of a player within the staging area is transmitted to all players in real time (i.e. with a negligible or not noticeable delay)

It is contemplated that a player's uncompleted move to place a bet can provide clues to the player's emotional state of mind. Thus, in an embodiment of an electronic poker game, a player can temporarily place a chip combination that represents a monetary amount for a bet (e.g., a betting amount) in a staging area before completing a bet or a turn. The staging area, which could be a component or portion of a graphical user interface, allows the player to contemplate on a betting amount before committing to a bet. Preferably, the player can make changes to the chip amount by adding chip(s) to, removing chip(s) from, or replacing chip(s) in the staging area before committing to the bet. In some embodiments, information of the betting amount (e.g., the total betting amount, chip combinations, etc.) that is placed in the staging area is provided to the other players via some sort of translated representation, and any changes to the betting amount will also be provided to the other players as soon as the changes are made.

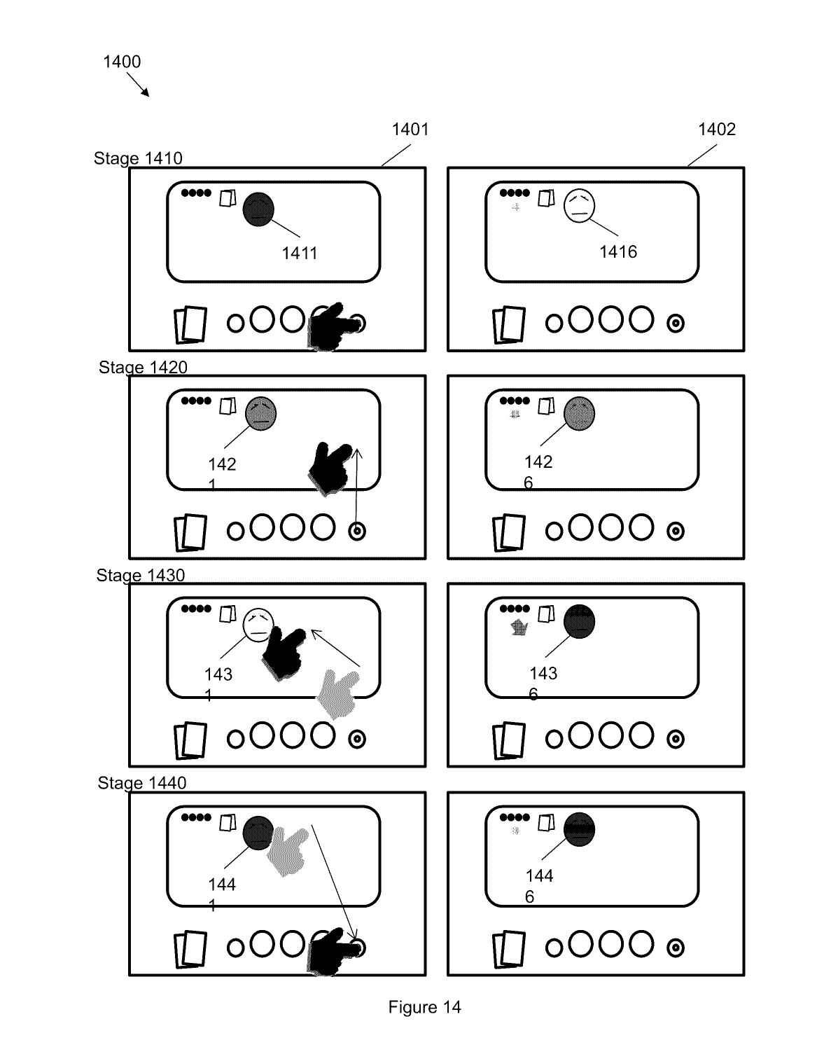

FIG. 15 illustrates details of one embodiment of a staging area module 142 that provides a staging area feature. Staging area module 142 includes an interaction reviewer 1511, a motion translator 1512, an object handler 1513, a stage monitor 1516, and a chip handler 1517. As shown, staging area module 142 is programmed to receive emotional inputs via server input 131. Emotional input interpreter 140 could be configured to determine that an input is related to the staging area before passing the inputs to the staging area module 142, or, preferably, staging area module 142 could be configured to review all inputs from server input 131 and filter accordingly using interaction reviewer 1511. Interaction reviewer 1511 reviews the inputs, and any interactions that occur in the staging area are sent to stage monitor 1516. Stage monitor 1516 is programmed to process the inputs to create a chip profile of the chips that are present within the staging area. The chip profile could include factors such as the number of chips, chip types, the movement of chips, etc. The chip profile is affected by the input actions that are performed by the player, for example by the player moving chips from the player's chip stack to the staging area, or from the staging area to the player's chip stack. Stage monitor 1516 then passes the chip profile to chip handler 1517, which then sends instructions to game session 123 to update the state of elements within the player's staging area within the poker game session.

Interaction reviewer 1511 could also be programmed to transmit recognized inputs received from server input 131 to motion translator 1512, where the inputs are translated into an emotional profile for the player who provided the input. Motion translator 1512 is programmed to accumulate inputs from each client device over a period of time and perform a set of analyses on the accumulated inputs to derive an emotional profile for the player associated with the client device. In some embodiments, motion translator 1512 is programmed to derive an emotional profile based on at least one or more of: a speed of the inputs, a direction of the inputs, a change of speed of the inputs, a pattern of the inputs, or other characteristics of the inputs. In some embodiments, motion translator 1512 is programmed to perform one or more pattern recognition analyses on the input data. Motion translator 1712 can store different input patterns associated with different emotional signals (such as nervous, scared, excited, etc.) in a database. Motion translator 1712 is programmed to match the accumulated inputs with at least one of the stored patterns to derive an emotional profile.

In yet other embodiments, motion translator 1712 can be programmed to store a staging profile for each player. The staging profile includes information about each player's historical movements in the staging area. For example, the staging profile could include information related to how quickly a player places a bet, the direction or magnitude of a player's movements of placing a bet, the pattern that a player follows when counting her chips, etc. In these embodiments, motion translator 1712 is programmed to compare the accumulated inputs with the player's historical inputs, and derive the emotional profile for that player based on a difference between the accumulated inputs and the historical inputs.

In one example, motion translator 1712 could observe that a player is spending more time placing a bet than what is typical for that player 1712. Based on this observation, motion translator could derive an emotional profile that indicates that the player could be nervous, for example.

Once the emotional profiles for the players are derived, motion translator 1712 sends the emotional profiles to object handler 1713 to translate the player's input actions into an emotional profile that is reflected by a representation of the player in game session 123. In some embodiments, staging area module 142 is programmed to present a graphical representation of the emotional profile to other players in the poker game. For example, while the system shows a player pulling chips in and out of the staging area, the system could alter a facial expression on the player's avatar to become more frantic or nervous (e.g., darken a color of the avatar's face and/or make sweat drops appear on the avatar's brow).

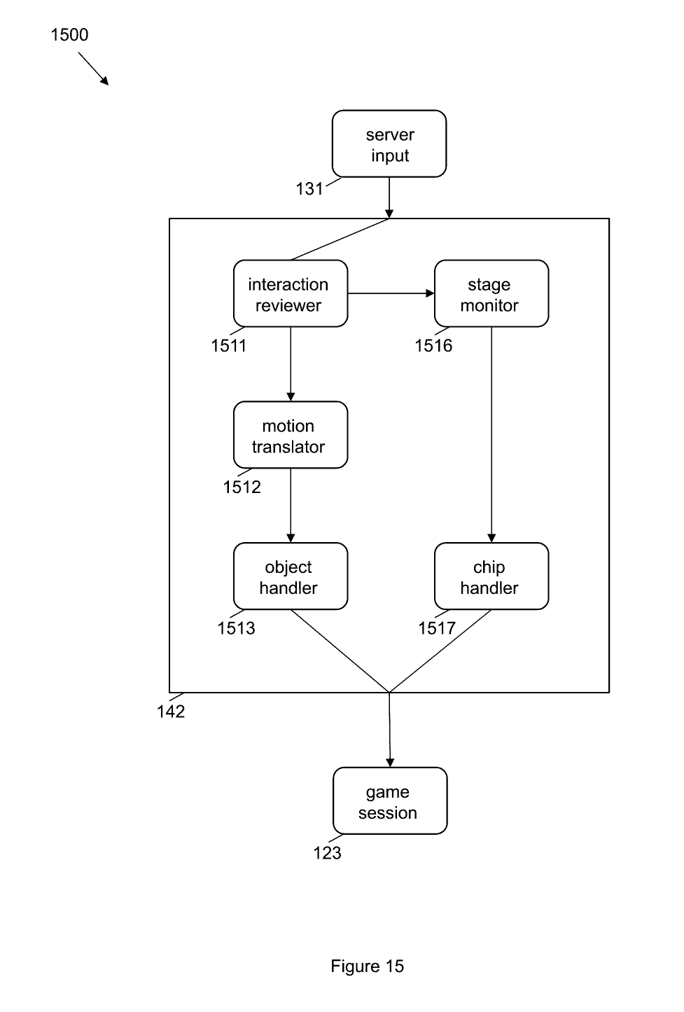

FIG. 16 illustrates a process 1600 for monitoring and translating motions within a staging area of the GUI of an electronic, networked poker game. Process 1600 begins with providing (at step 1605) a staging area as part of the graphical user interface. The process detects (at step 1610) whether there is a user action within the staging area (e.g., dragging chips to the staging area, dragging chips away from the staging area, pulling up a menu to switch chips within the staging area). The process then translates a recognized user action into a representation and updates (at step 1615) the staging area according to the user action. After updating the staging area, the process generates (at step 1617) an emotional profile and presents it to other players. If the user action is adding chips to the staging area (at step 1620), the process updates the emotional profile (at step 1635), then returns to receiving inputs at step 1610. If the user action is removing chips to the staging area (at step 1625), the process also updates the emotional profile (at step 1635), then returns to step 1610 to receive additional inputs. On the other hand, if the action is placing a bet (at step 1630), the process ends monitoring the staging area.

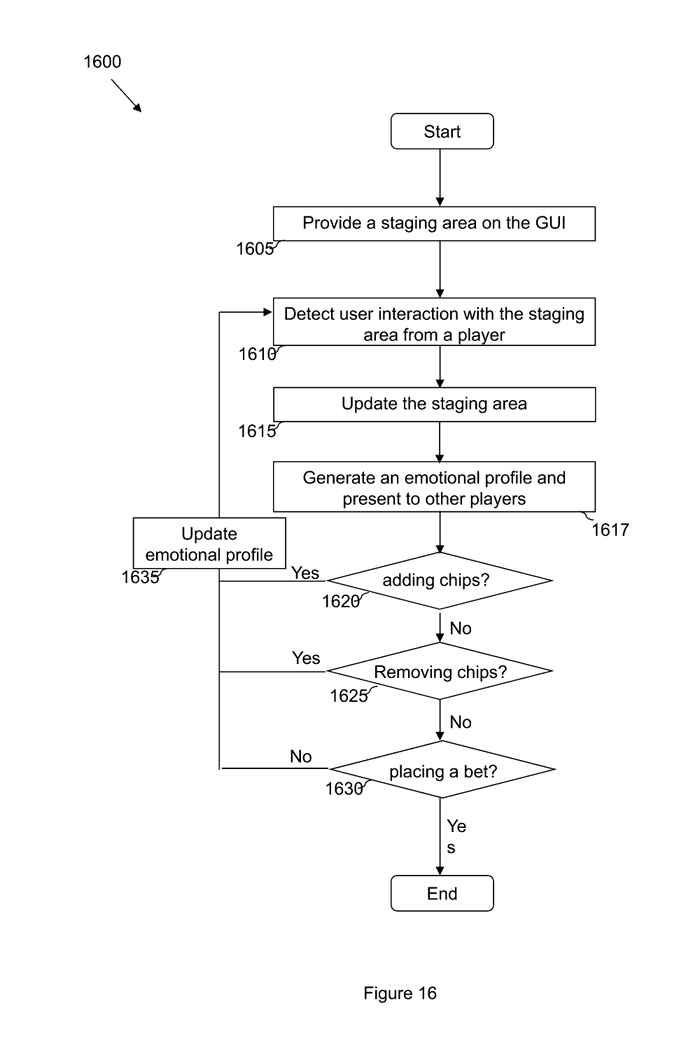

FIG. 17 illustrates the operation of presenting the contemplated moves on a touch sensitive screen in the staging area of a player who is in the process of making a bet to another player, via four stages 1705, 1710, 1715, 1720.

Stage 1705 shows the views of two players (Player A and Player B, respectively) while they are playing an electronic, networked poker game via server 130. View 1725 represents a view of Player A, and view 1730 represents a view of Player B. In this example, it is Player A's turn to make a bet in the poker game, and Player B is waiting for Player A to make the bet. As shown in stage 1705, Player A is contemplating making a bet by selecting chips with his finger in staging area 1745. In response to this input, the GUI is programmed to show Player B a visual representation 1735 that Player A is contemplating making a bet.

In stage 1710, Player A contemplates making a bet by dragging his chip selection 1750 away from staging area 1745 toward the common area 1722. In some embodiments common area 1722 can be the center of the table or playing area, but the location of common area 1722 could differ for different types of games. In some embodiments, objects or elements (e.g., poker cards, chips, etc.) located in the common area 1722 are not controllable by the players.

As a result of Player As actions in stage 1710, the GUI is programmed to show Player B (in view 1730) a visual representation that Player A is moving his chips. In this example, the GUI is programmed to show Player B an arrow 1755, which is configured to show the direction Player A is moving his chips.

In stage 1715, Player A changes the direction and speed of his move (1760). As a result, the GUI is programmed to change arrow 1755 (in view 1730) in size and direction to indicate the change in direction and speed of Player A's move. In preferred embodiments, the GUI is programmed to change arrow 1755 in real-time (e.g., within 0.5 seconds) to reflect the change in behavior of Player A.

In stage 1720, Player A has completes his turn by releasing his finger from the screen. As a result, the GUI is programmed to show Player B chips being thrown in the table. It is also contemplated that in some embodiments the visual representation of Player A actions which the GUI is programmed to show to Player B in view 1730 could also include the number of chips selected, the speed at which Player A is counting his chips, the speed with which Player A places a bet, etc.

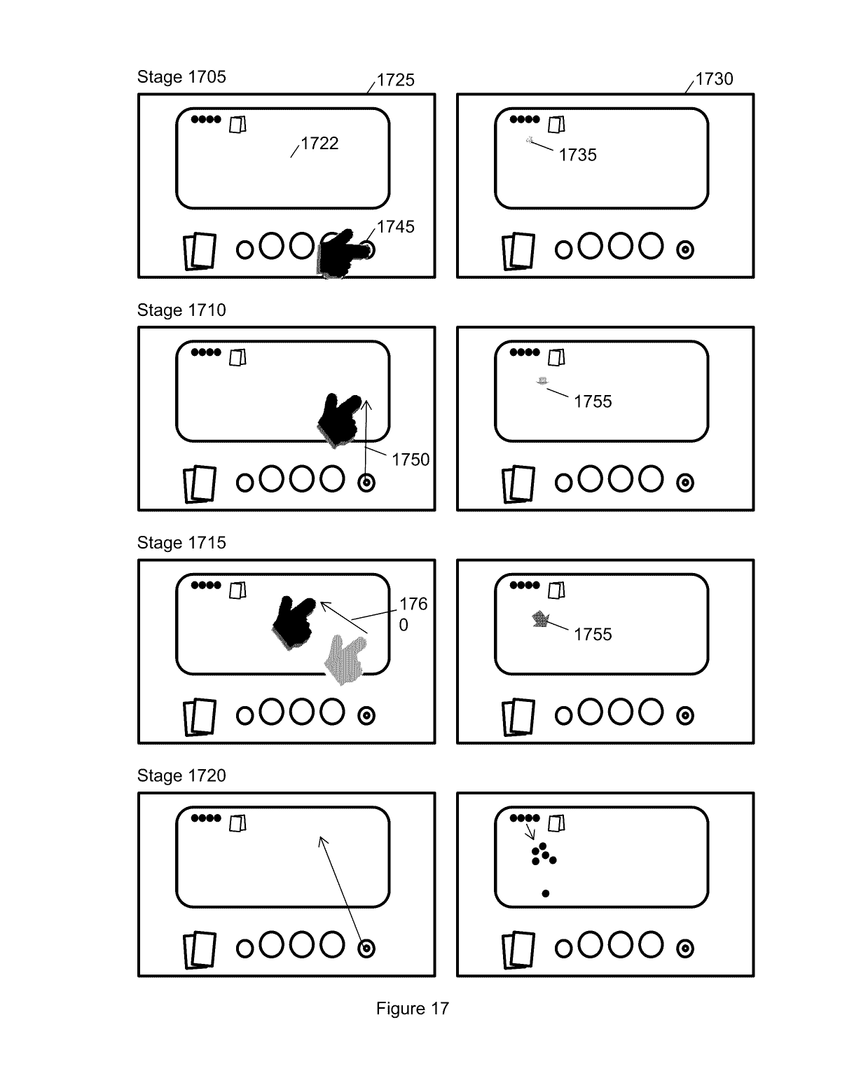

The operational example in FIG. 18 is similar to that in FIG. 17, but illustrates an operational example when one player contemplates, but does not complete, a move. As a result, stages 1805, 1810, and 1815 of FIG. 18 have similar graphical representations to stages 1705, 1710, and 1715 of FIG. 17, while stage 1820 of FIG. 18 has differing graphical representations from stage 1720 of FIG. 17.

Stage 1805 is similar to stage 1705 of FIG. 17. In view 1830, the GUI is programmed to show Player B that Player A is contemplating placing a bet from staging area 1845.

As in stages 1710 and 1715, stages 1810 and 1815 show that Player A drags his selection of chips from the staging area and moves them to the common area. In response, the GUI is programmed to show Player B these moves in a manner similar to that in FIG. 16.

However, in stage 1820 of FIG. 18 Player A does not complete the bet. In stage 1820, Player A does not ‘release’ his chip selection. Instead, he drags his selection back to the staging area. As a result, in stage 1820, the GUI is programmed to show Player B that Player A did not complete the action.

Although most embodiments described herein describe a staging area for an electronic, networked poker game, staging areas for other types of electronic, networked games are contemplated. It is contemplated that deriving an emotional profile of a player could be useful in other games besides poker.

UI Dial

Another approach provides for a graphical user interface (GUI) on a touch-sensitive device that includes a dial control that allows a player to select different poker chip combinations (which correspond with different monetary amounts) to be used during his turn. This GUI configuration allows for the player to easily view and select different chip combinations, and to trade up or down existing chips. Preferably, a different dial is provided for each type of poker chips (having a different monetary value).

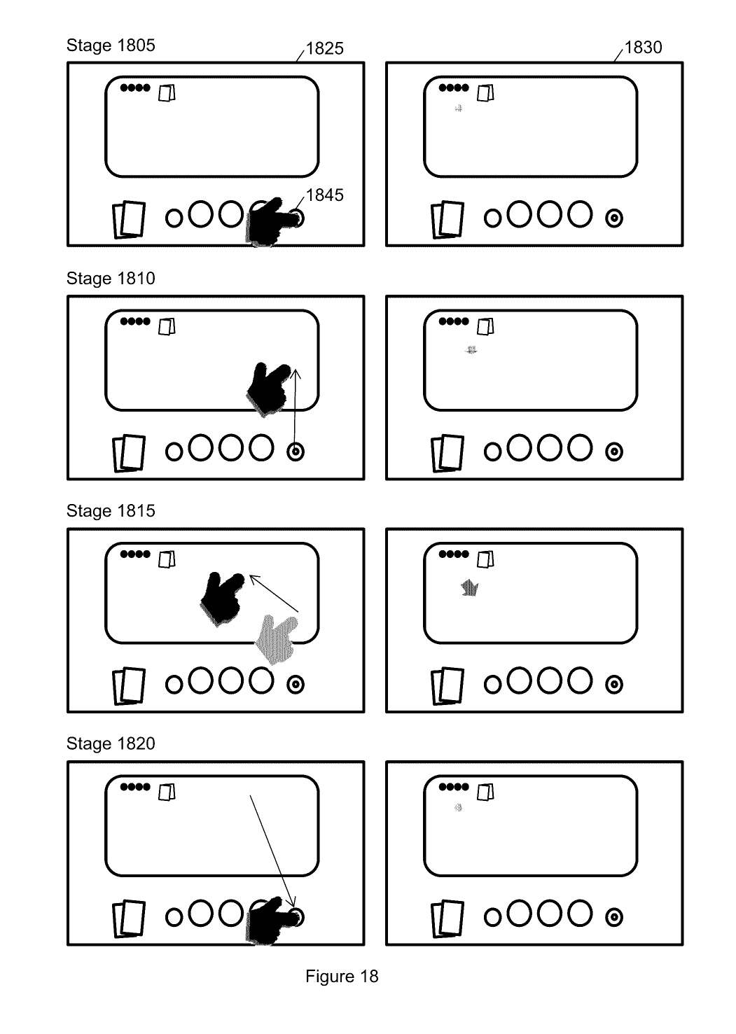

FIG. 19 illustrates an exemplary software architecture for UI dial module 143 of server 130. UI dial module 143 includes an interaction reviewer 1911, a motion translator 1912, an object handler 1913, a dial monitor 1916, and a chip handler 1917. Interaction reviewer 1911 receives players' inputs (via the players' respective client devices) from server input 131. As mentioned above, emotional input interpreter is programmed to pass only the inputs that are determined to be relevant to the dial control to UI dial module 143.

Upon receiving a dial input, interaction reviewer 1911 is programmed to send the dial input to dial monitor 1916 to process the input. Dial monitor 1916 is programmed to interpret the dial input and advance the state of the poker game according to the dial input. In some embodiments, dial monitor 1916 is also programmed to pass the advancement of the poker game's state to chip handler 1917, which in turn is programmed to provide updates to game session 123. For example, when a player selects one of the dial controls that corresponds to a particular chip type on the GUI, chip handler 1917 is programmed to provide game session 123 with instructions to present several graphical representations surrounding the circumference of the dial. In some embodiments, each of the several graphical representations corresponds to a different quantity of chips belonging to the chip type associated with the dial control. In addition, at least one of the graphical representations surrounding the circumference of the dial control corresponds to a “trade-up” selection and at least one of the graphical representations surrounding the circumference of the dial control corresponds to a “trade-down” selection.

In some embodiments, UI dial module 143 is programmed to receive an input that indicates a player contemplating a selection of one of the graphical representations. For example, a player could contemplate on a selection of one of the graphical representations by putting a finger on an area of the touch-sensitive screen that displays the graphical representation, without releasing the finger. When a player contemplates one of the feature (e.g., a chip quantity, a trade up, a trade down, etc.), UI dial module 143 is programmed to present a graphical representation of such a contemplation to other players in the poker game.

At this point, the player could change his mind on the chip quantity by, for example, moving the finger over to other areas of the touch-sensitive screen that display the other graphical representations, or even retract the selection of the chip type by, for example, moving the finger over to the dial control area and releasing the finger. In some embodiments, UI dial module 143 is also programmed to present these changes in a graphical representation to other players in the poker game.

When a player selects one of the graphical representations surrounding the dial control that corresponds to a quantity (e.g., by releasing a finger that was placed on the graphical representation that corresponds to the quantity), chip handler 1917 is programmed to “move” that quantity of chips associated with the chip type to an area (e.g., the staging area) for betting. On the other hand, when a player selects one of the graphical representations surrounding the dial control that corresponds to a “trade-up” or a “trade-down” selection, chip handler 1917 is programmed to perform the corresponding trade-up or trade-down operation of the chips in the chip type. In some embodiments, UI dial module 143 is also programmed to present the selection to the other players in the poker game.

In addition to passing the dial inputs to dial monitor 1916, interaction reviewer 1911 is also programmed to send the dial inputs to motion translator 1912. Motion translator 1912 is programmed to derive an emotional profile from the dial inputs. In some embodiments, motion translator is programmed to accumulate the dial inputs over a period of time and derive the emotional profile from the accumulated dial inputs.

In some embodiments, motion translator 1912 is programmed to derive an emotional profile based on at least one of the following: a speed of the inputs, a change of speed of the inputs, a pattern of the inputs, or other characteristics of the inputs.

Specifically, motion translator 1912 is programmed to perform one or more pattern recognition analyses on the input data. For example, motion translator 1912 can store different input patterns in a storage (medium). Each pattern can be associated with an emotional signal (e.g., nervous, scared, excited, etc.). Motion translator 1912 is programmed to match the accumulated inputs with at least one of the stored patterns to derive the emotional profile.

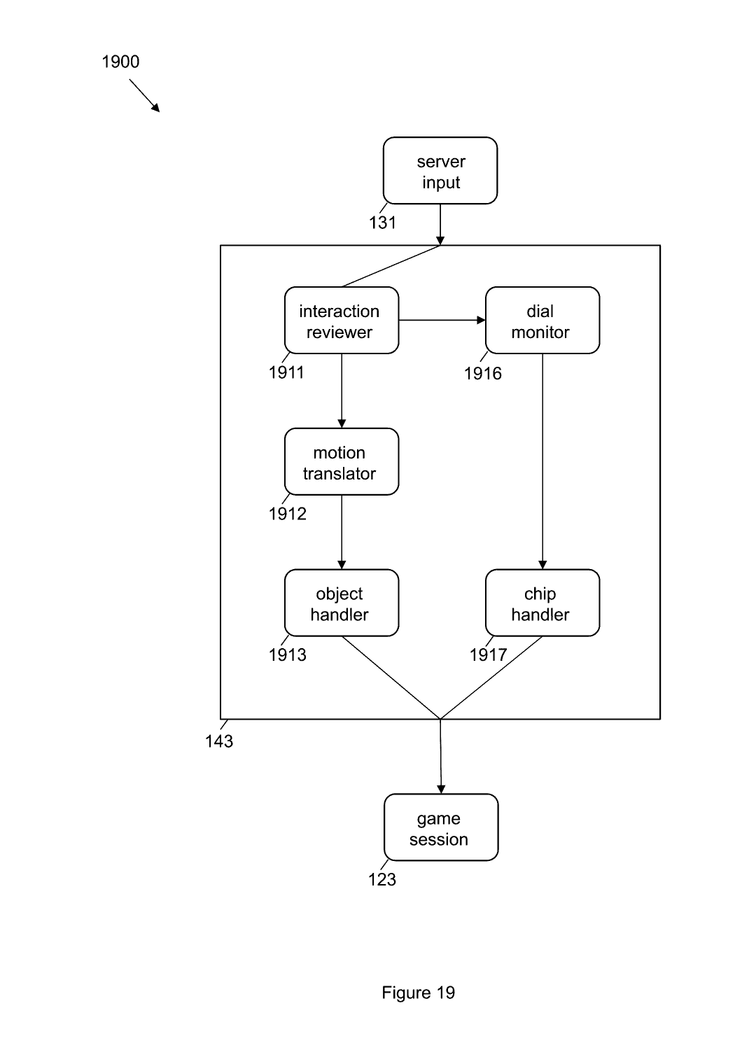

FIG. 20 illustrates a state diagram 2000 that represents the operations of UI dial module 143 across three different states: idle state 2005, chip selection state 2010, and trade-in state 2015. UI dial module 143 begins in idle state 2005, where a dial control is presented to a player via a graphical user interface. When a player selects a dial control, UI dial module 143 transitions to chip selection state 2010 that enables a player to select a chip quantity. UI dial module also displays graphical representations corresponding to different chip quantity surrounding the dial control. At this chip selection state 2010, a player can do one of four things. The player can select a chip quantity (e.g., by releasing the finger that was placed on a graphical representation corresponding to a chip quantity, etc.), in which case UI dial module 143 will return to idle state 2005. Alternatively, the player can withdraw from selecting the dial control (e.g., by releasing the finger that was placed on the dial control, etc.), in which case UI dial module 143 will also return to idle state 2005. The player can also contemplate different chip amounts (e.g., by placing the finger on any one of the graphical representation surrounding the dial control and corresponding to different chip quantities, etc.), in which case UI dial module 143 will remain in chip selection state 2010. Finally, the player can select trading-in the chips, by selecting a graphical representation corresponding to a trade-down selection or a graphical representation corresponding to a trade-up selection, and UI dial module 143 will transition to trade-in state 2015.

In trade-in state 2015, the player can do one of three things. The player can complete a trade-in, in which case UI dial module 143 returns to idle state 2005. Alternatively, the player can withdraw from the dial control (e.g., by releasing the finger that was placed on the dial control, etc.), in which case UI dial module 143 also returns to idle state 2005. The player can also select a trade-down or a trade-up, in which case UI dial module 143 returns to chip selection state 2010.

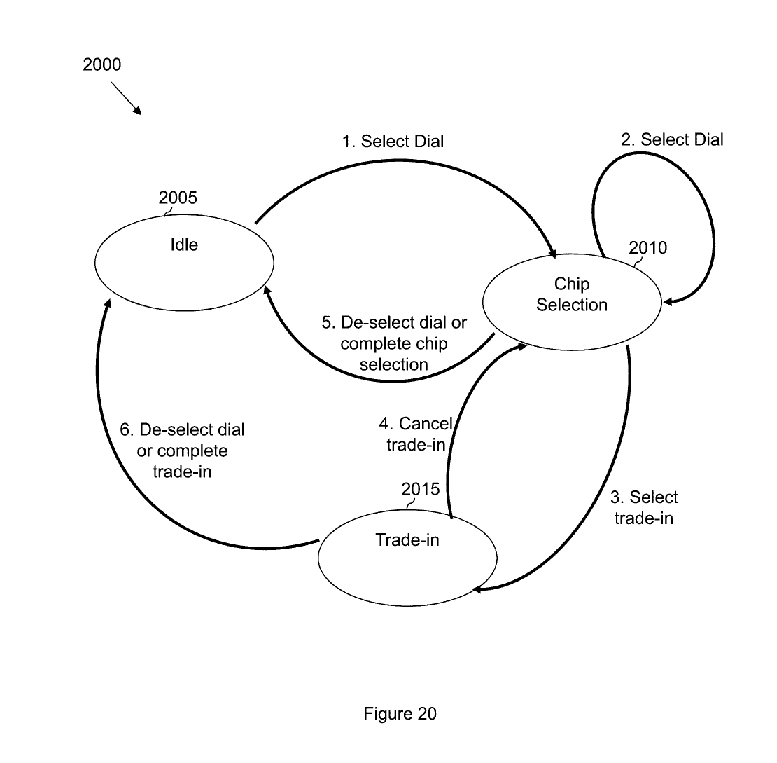

The operations of UI dial module 143 are further described below by way of several operation examples illustrated through FIGS. 21, 22, and 23. Specifically, FIG. 21 illustrates the operation of selecting a chip type and quantity in the process of making a bet, via three stages 2105, 2110, and 2115.

Stage 2105 shows the views of two players (Player A and Player B) while they are playing an electronic, networked poker game via server 130. View 2120 represents a view of Player A and view 2125 represents a view of Player B. In this example, it is Player A's turn to make a bet in the poker game, and Player B is awaiting Player A to make the bet. As shown, view 2120 includes a graphical representation of a poker table 2130, a graphical representation of Player A's cards 2135, dial controls 2140a, 2140b, and 2140c, and a staging area 2145. Each dial control corresponds to a distinct chip type. In this example, dial control 2140a corresponds to a $5 chip type, dial control 2140b corresponds to a $10 chip type, and dial control 2140c corresponds to a $20 chip type.

View 2125 shows similar elements as view 2120, except that view 2125 also includes a display area located on the top left corner of poker table 2150 for displaying a graphical representation of Player A's activities/emotional state.

In stage 2105, Player A has selected dial control 2140c corresponding to the $20 chip type. In response to the selection of dial control 2140c, UI dial module 143 is programmed to present graphical representations (e.g., graphical representations 2160a, 2160b, and 2160c, etc.) corresponding to different chip quantity around at least a portion of the circumference of dial control 2140c. In some embodiments, the graphical representations 2160a, 2160b, and 2160c only occupy a portion of the circumference of dial control 2140c while in other embodiments, the graphical representations occupy the entire circumference of dial control 2140c. As shown in stage 2105, each graphical representation surrounding the circumference of dial control 2140c occupies a distinct range of arc degrees with respect to the center of dial control 2140c. As such, Player A can select any one of the graphical representations 2160a-2160c by moving the finger outward from the center of dial control 2140c.

In addition, UI dial module 143 is also programmed to present the selection of dial control 2140c to Player B as shown by graphical representation 2155 in view 2125. In this example, graphical representation 2155 is shown to be an incomplete dial divided into different sections, where each section corresponds to a distinct chip quantity of the chip type selected by Player A.

In stage 2110, Player A contemplates on a particular chip quantity by dragging the finger to one of the graphical representations 2160a-2160c. In response to this input, UI dial module 143 is programmed to present an animation to Player A to represent the contemplation of selecting the particular chip quantity by, for example, enlarging the graphical representation 2160b that corresponds to the particular chip quantity, as shown in view 2120 of stage 2110.

In addition, UI dial module 143 is also programmed to update the view for Player B based on Player A's action. In this example, UI dial module 143 also updated graphical representation 2155 in view 2125 to indicate Player A's contemplation on the particular chip quantity, by enlarging the section of the graphical representation 2155 that corresponds to the particular chip quantity.

In stage 2115, Player A completes the selection of the particular chip quantity by, for example, releasing the finger that was placed on the graphical representation 2160c. In response, UI dial module 143 is programmed to update the game session 123 and to indicate to both Player A and Player B of this action. As shown, chips that corresponding to the selected chip type and chip quantity are displayed in staging area 2145 in view 2105, and chips that corresponding to the selected chip type and chip quantity are displayed in a section of table 2150 in view 2125.

Preferably, the system is configured such that Player A could move the finger to the bottom empty area of UI dial 2140c at any time to cancel the bet. Since the tabs on the UI dial do not form a complete circle, the bottom area could be an “invisible tab” that, when a user moves the finger to that area, the user cancels the bet.

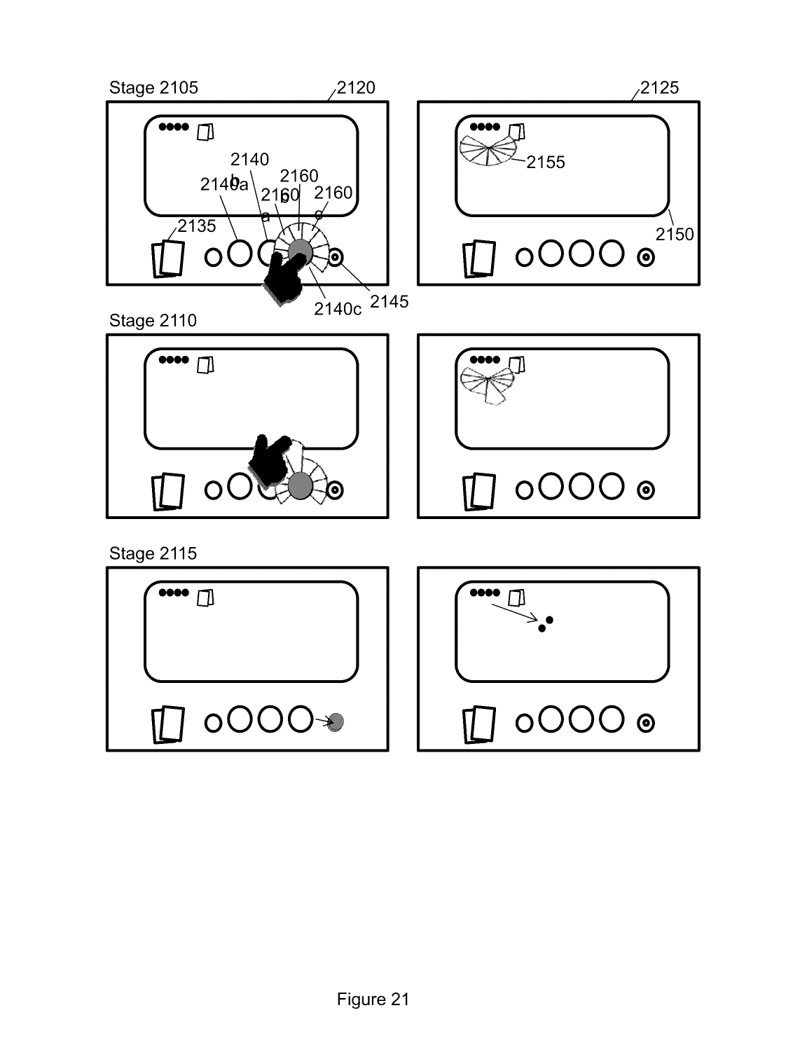

Similar to FIG. 21, FIG. 22 illustrates the operation of selecting a chip type and quantity in the process of making a bet, via three stages 2205, 2210, and 2215. Stages 2205 and 2210 of FIG. 22 are substantially similar to stages 2105 and 2110 of FIG. 21. Player A has the option to select different chip quantities, and Player B is shown the different chip quantities that Player A is contemplating in real-time. However, in contrast with FIG. 21, Player A in FIG. 22 does not complete a chip selection. As a result, in stage 2215 Player B is shown that Player A has not yet made a chip selection.

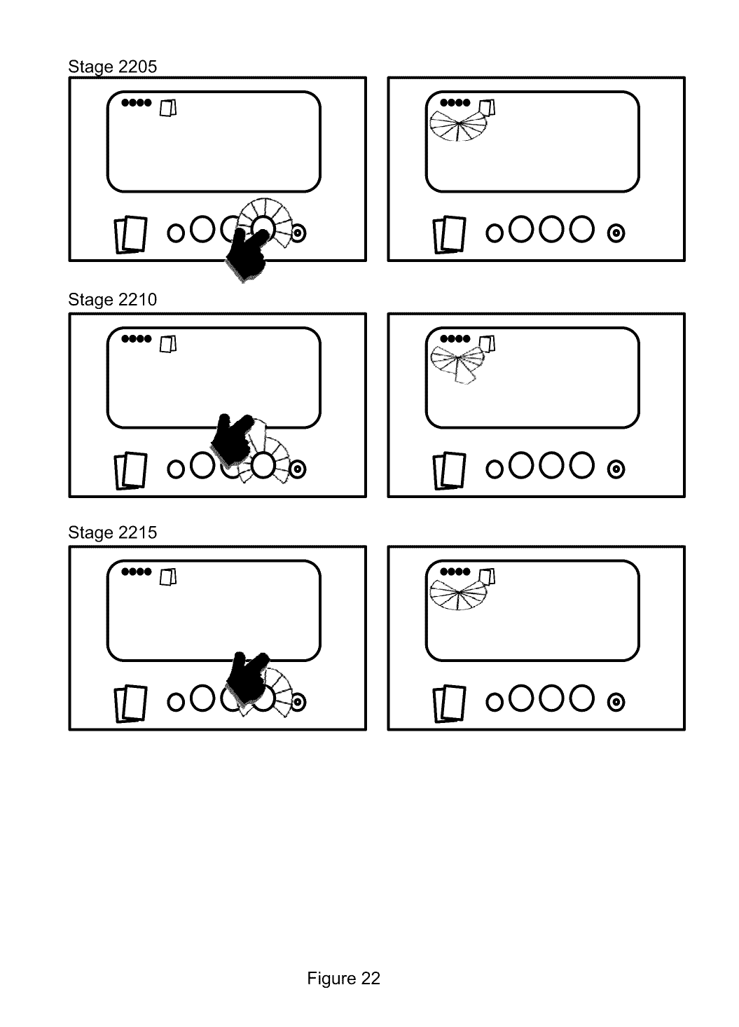

FIG. 23 is similar to FIG. 22 and FIG. 21, except that FIG. 23 illustrates the operation of “trading-up” or “trading-down” a chip type and quantity in the process of making a bet, via three stages 2305, 2310, and 2315.

Stage 2305 is similar to stage 2205 of FIG. 22 and 2105 of FIG. 21. Similar to FIGS. 22 and 21, stage 2305 shows the view of Player A and Player B when it is Player A's turn to make a bet in a poker game.

However, stage 2310 is different than stage 2210 in FIGS. 22 and 2110 in FIG. 21. In stage 2310, Player A selects the “trading down” option 2370 on dial control 2340c, which corresponds to a $20 chip type. Accordingly, Player B is shown a view of Player A trading down.

Stage 2315 shows that Player A has ‘traded down’ to select dial control 2340b, which corresponds to a $10 chip type. In this stage, Player B is shown that Player A has selected a $10 chip type.

Minigame

It is known that many poker players perform certain repetitive motions (e.g., playing with a poker chip, etc.) while waiting for their turns or contemplating a decision in their turns. Players perform these repetitive motions for several reasons—(1) to keep them entertained while waiting for their turns or while contemplating a game action and (2) to show other players their proficiency in the game.

Thus, the manner in which a player performs the repetitive motions (e.g., the speed or the change of speed at which the player is performing the repetitive motions, etc.) could provide a clue to the player's state of mind. Thus, in yet another aspect of the inventive subject matter, a stand-alone minigame is provided to the players while the players are playing the electronic, networked game (e.g., poker game). The minigame is separate from, and not affected by, the state of the electronic, networked game. Preferably, the minigame requires a set of repetitive motions from each player. The repetitive motions performed by each player while playing the minigame are detected and analyzed. In addition, an emotional profile is derived for each player based in part on the analysis of the repetitive motions, and a representation of the emotional profile is presented to the other players in the game.

Tminigame is a stand-alone game that is played independently by each player (i.e., the players do not play the minigame with each other). It is preferable that the minigame can keep a score for each player that corresponds to how well the player does in that minigame. The minigame can provide a score that represents how fast the player performs a certain task successfully, how well the player performs the task, and/or how many tricks the player can do while performing the task.

Different embodiments can provide different minigames to the players. Examples of such minigames can include a chip flipping game in which a player provides a series of input that includes a force input and a direction input to flip a chip in the air and a series of input to catch the chip. Another example can be a chip rolling game, in which a player provides a series of repetitive inputs to keep the chip rolling thorough the fingers of a virtual hand.

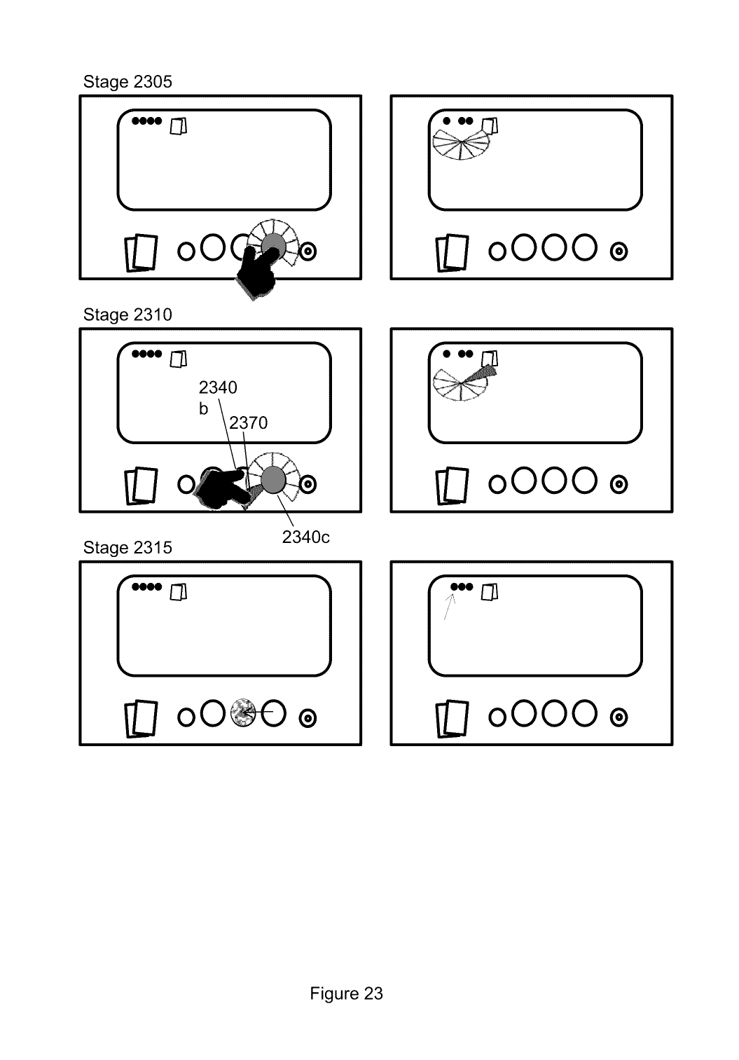

FIG. 24 illustrates details of minigame module 124 that provides such a minigame feature. Minigame module 124 includes an interaction reviewer 2411, a motion translator 2412, an object handler 2413, and a minigame controller 2416. As shown, minigame module 124 is programmed to receive inputs 131 from emotional input interpreter 140. As mentioned above, emotional input interpreter 140 is programmed to determine that an input is related to the minigame before passing the input to minigame module 124. Interaction reviewer 2411 is programmed to pass the input to minigame controller 2416 for controlling the flow of the minigame. The minigame controller 2416 is programmed to process the inputs to produce minigame result 2417 and passes the minigame result 2417 to game session 123.

In addition, interaction reviewer 2411 is also programmed to pass the same input to motion translator 2412, where the inputs are being analyzed. Motion translator 2412 is programmed to accumulate the inputs from each client device over a period of time and perform a set of analysis on the accumulated inputs to derive an emotional profile for the player associated with the client device.

In some embodiments, motion translator 2412 is programmed to derive an emotional profile based on at least one of the following: a speed of the inputs, a change of speed of the inputs, a pattern of the inputs, or other characteristics of the inputs.

Specifically, motion translator 2412 is programmed to perform one or more pattern recognition analyses on the input data. For example, motion translator 2412 can store different input patterns in a storage. Each pattern can be associated with an emotional signal (e.g., nervous, scared, excited, etc.). Motion translator 2412 is programmed to match the accumulated inputs with at least one of the stored patterns to derive the emotional profile.

In yet other embodiments, motion translator 2412 is programmed to store a minigame profile for each player. The minigame profile includes information of the player's historical inputs associated with the minigame. In these embodiments, motion translator 2412 is programmed to compare the accumulated inputs with the player's historical inputs, and derive the emotional profile for that player based on a difference between the accumulated inputs and the historical inputs.

Once the emotional profiles for the players are derived, motional translator 2412 sends the emotional profiles to object handler 2413 to incorporate the emotional profiles into game session 123.

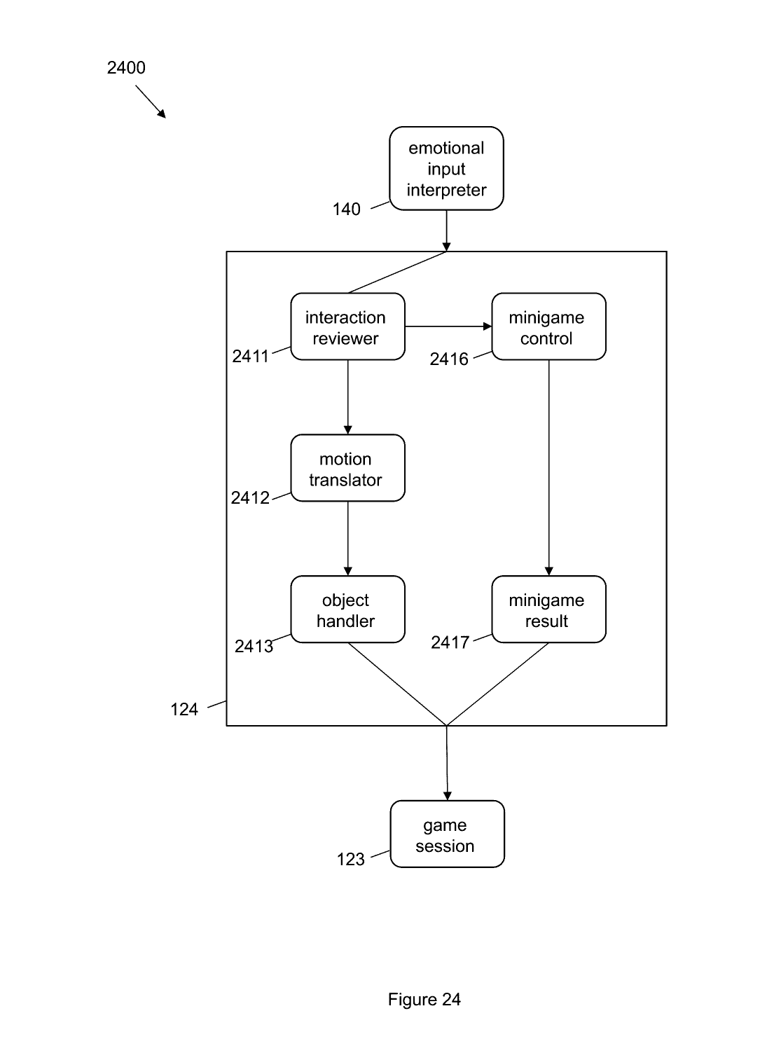

FIG. 25 illustrates a process 2500 for providing a minigame in an electronic, networked poker game. Process 2500 begins with providing (at step 2505) a minigame that requires repetitive motions to a player and begins receiving inputs. The process 2500 then determines (at step 2510) whether the input corresponds to a minigame action. If the input does not correspond to a minigame action, the process returns to step 2505 and continues to receive inputs. On the other hand, if the input corresponds to a minigame action, the process 2500 monitors (at step 2515) attributes related to how the first player plays the minigame. In some embodiments, the process 2500 monitors the attributes by accumulating inputs that correspond to the minigame and performs numerous analyses on the inputs as described above.

Based on the analyses, the process 2500 generates (at step 2520) an initial emotional profile of the player. The process 2500 then provides (at step 2525) a graphical representation of the emotional profile to other players in the poker game. The process 2500 continues (at step 2530) to monitor attributes related to how the player plays the minigame.

As the process 2500 continues to monitor the attributes related to how the player plays the minigame, the process 2500 determines (at step 2535) whether there is any change in the attributes. If it is determined that there is no change in the attribute, the process 2500 returns to step 2530 to continue to monitor the attributes. On the other hand, if it is determined that there is a change in attribute (e.g., a change in the speed of the inputs, a change in a pattern of the inputs, etc.), the process 2500 updates (at step 2540) the emotional profile for that player.

The process 2500 also continues to repeat the monitoring attribute and updating emotional profile steps until the game ends, as determined at step 2545.

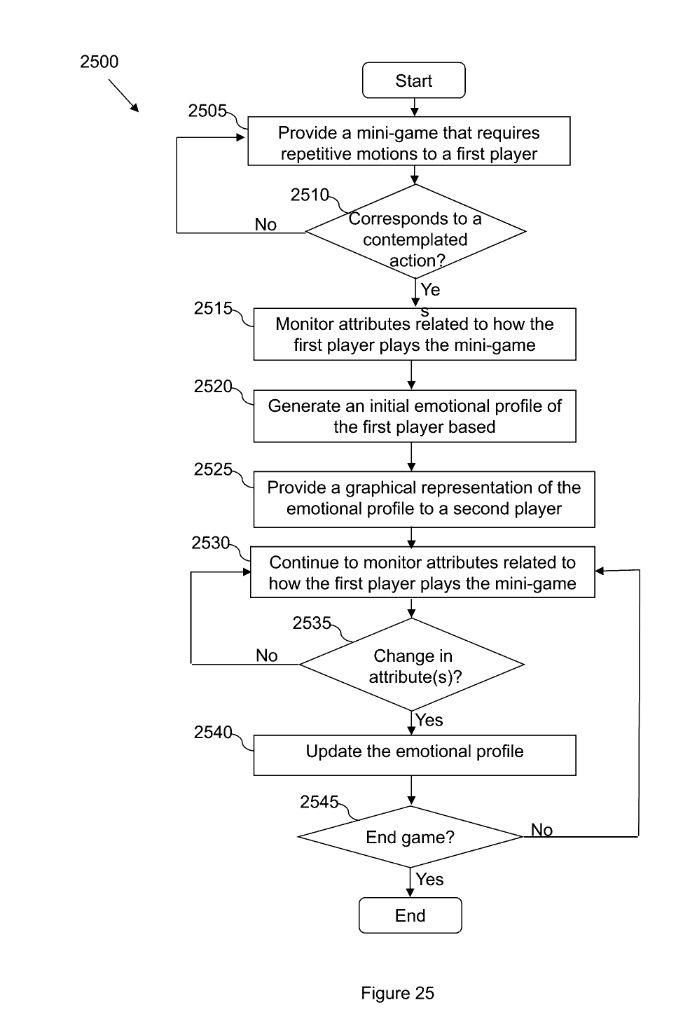

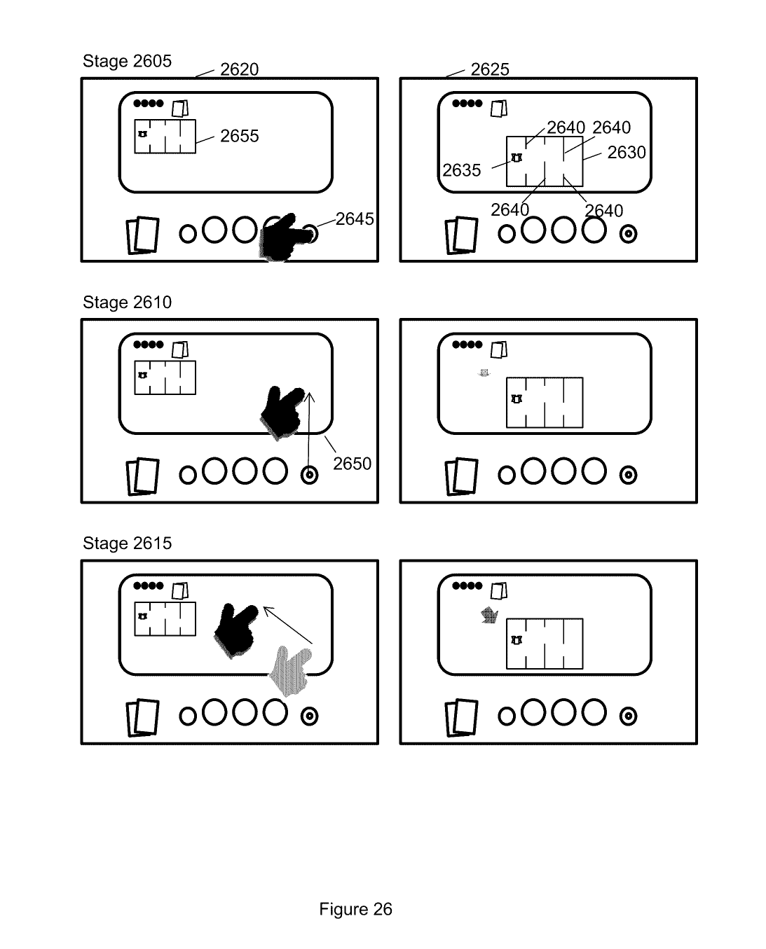

The operations of minigame module 124 are further described below by way of several operation examples illustrated through FIGS. 26 and 27. Specifically, FIG. 26 illustrates the operation of presenting, to a player who is in the process of making a bet, the emotional profile of another player that is derived from the minigame via three stages 2605, 2610, and 2615.

Stage 2605 shows the views of two players (Player A and Player B) while they are playing an electronic, networked poker game via server 130. View 2620 represents a view of Player A and view 2625 represents a view of Player B. In this example, it is Player A's turn to make a bet in the poker game, and Player B is awaiting Player A to make the bet. As shown, a minigame 2630 is provided to Player B via the graphical user interface. In this example, the minigame 2630 is an “endless flyer” game, in which the player would attempt to move an object 2635 between the left edge and the right edge of the game 2630 without allowing object 2635 come in contact with obstructions (represented by lines 2640). On a touch sensitive display, a player could use a finger to “drag” object 2635 back and forth between the left and right edges.

View 2620 shows that Player A is contemplating making a bet with the chips placed in staging area 2645 by selecting the chips in staging area 2645. As shown, view 2620 also provides a graphical representation of the minigame 2655 that is being played by Player B. As such, Player A can see the manner (or the change of manner) in which Player B plays the minigame as Player A makes a move.

Stage 2610 shows that Player A is beginning the process of making a bet with the chips placed in staging area 2645 by dragging the chips from staging area 2645 to virtual poker table 2650. As shown, view 2620 provides Player A with any updates of Player B's minigame 2630. At this stage 2615, Player A can decide to complete the betting move or decide to make changes to the bet, based on the observation of the manner in which Player B's playing the minigame 2630.

Stage 2615 shows that Player A has decided to complete the bet by dragging the chips further into the table 2650.

FIG. 26 illustrates an operation example of providing a minigame during an electronic, networked poker game in which a graphical representation of the minigame being played by one player is provided to the other player(s). FIG. 27 illustrates a similar operation of providing a minigame, except that a graphical representation of an emotional profile of the player playing the minigame is provided to the other player(s).

Stage 2705 is similar to stage 2605 of FIG. 26, except that view 2720 of Player A shows a graphical representation of the emotional profile of Player B 2730 derived in part from the manner in which Player B plays the minigame 2630. In some embodiments, the emotional profile of Player B can be derived using methods described above. For example, the emotional profile of Player B can be derived from the speed in which Player B moves object 2635 between the left and right edges in the minigame 2630, or from a change of speed in which Player B moves object 2635 between the left and right edges in the minigame 2630, or from the amount of unnecessary movement of object 2635 (e.g., shaking, etc.), or any combination thereof. In some embodiments, the sudden change in speed indicates a higher level of anxiety. Similarly, increase of unnecessary movement of object 2635 also indicates a higher level of anxiety.

In this example, the graphical representation of Player B's emotional profile 2730 is a face having a color lightness. The darker the color of the face 2730, the more anxious is Player B's emotional profile. Stage 2610 illustrates the emotional profile of Player B increasing in anxiety (as shown by the darker color of representation 2730) as Player B moves the chips towards poker table 2650. Stage 2715 illustrates that the emotional profile of Player B becomes even more anxious as Player A is completing the betting move.

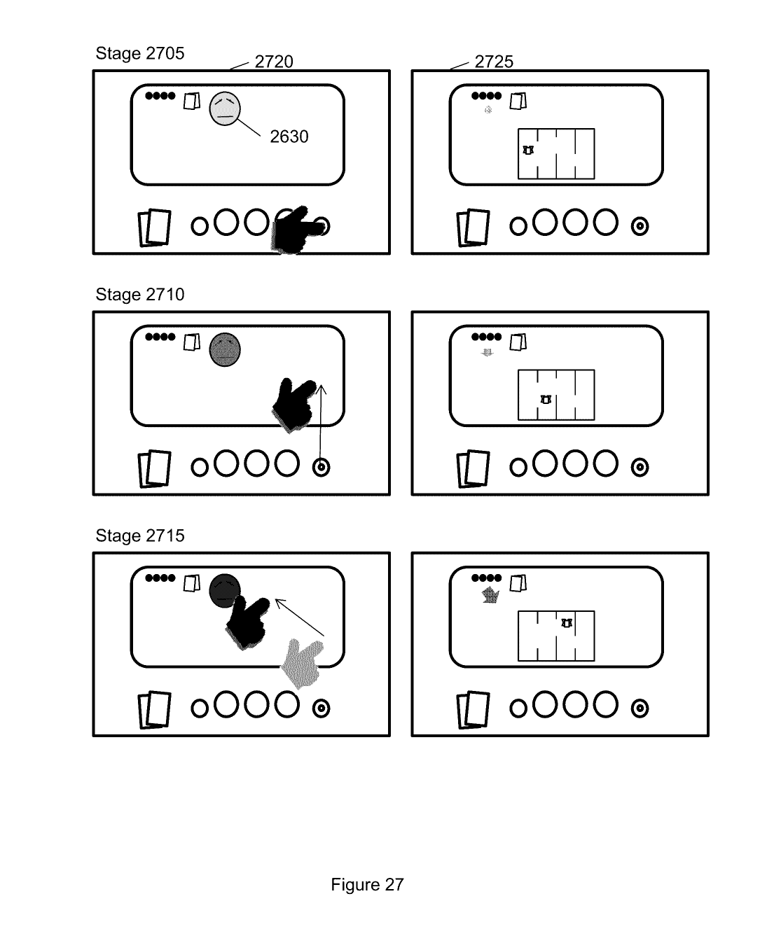

FIG. 28 illustrates an exemplary hardware architecture of a poker system 2800 that enables the derivation of emotional profiles of the players and presenting the emotional profiles to other players during an electronic, networked poker game. As shown, the poker system 2800 includes a server 130 that either includes or electronically coupled with a storage 2832. Storage 2832 includes non-transitory medium (e.g., a hard drive, a flash drive, a memory, a solid-state drive, etc.) that is configured to store data that is related to the poker system 2800, such as the state of each poker games that is being facilitated by server 130, data related to emotional profiles of the players, etc.

Server 130 includes at least one physical processing unit (e.g., a processor, a processing core, etc.) and a memory. The memory stores software instructions associated with the different modules—real-time motion module 141, staging area module 142, UI dial module 143, and biometric transformer module 144, etc. The at least one physical processing unit performs the features and functions of the different modules of server 130 by executing the software instructions stored in the memory.

As shown, server 130 is communicatively coupled with several client devices, such as client devices 2812, 2814, and 2816 over a network 2840 (e.g., the Internet, a wide area network, a local area network, etc.). Client devices 2812, 2814, and 2816 can include any user computing device such as a personal computer, a smart phone, a tablet, a phablet, etc. Server 130 is programmed to enables players to play an electronic, networked game (e.g., an online poker game) with one another over network 2840.

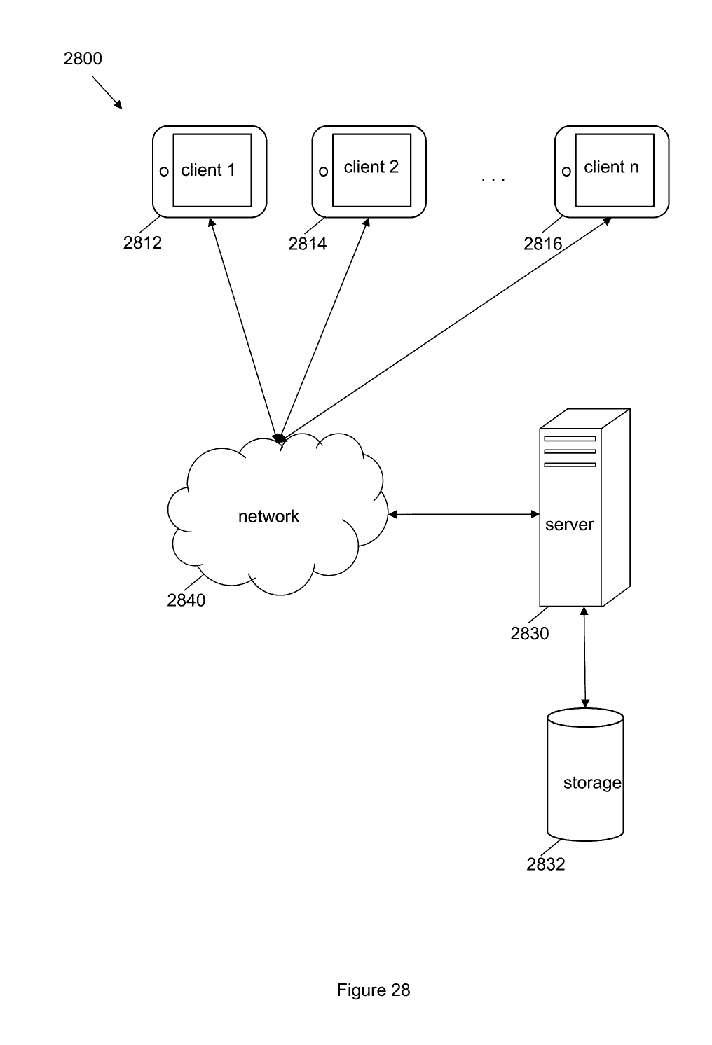

FIGS. 29A and 29B show virtualized representations 2900 and 2905 of a poker table 2800. Server 130 generally creates a virtualized representations 2900 and 2905 of poker table 2810 surrounded by player chairs 2920a, 2920b, 2920c, 2920d, 2920e (not shown) and 2920f (not shown). Each of the player chairs are virtualized to scale relative to poker table 2910. Virtual camera 2930 is a virtualized representation of a camera lens at a point above table 2910 that captures the size and movements of cards and chips on table 2910, and player chairs 2920a, 2920b, 2920c, 2920d, 2920e, and 2920f. In a preferred embodiment, camera 2930 is located approximately three times the height of table 2910 and three times the width of table 2910 and is aimed at a center of table 2910 to capture the entirety of virtualized table 2910 and the surrounding player chairs 2920a, 2920b, 2920c, 2920d, 2920e, and 2920f. In an exemplary embodiment, camera 2930 could be aimed 33 degrees down from horizontal to capture the perspective view of the table. The camera could be fitted with two or more virtual lenses to capture a normal horizontal field of view 2912 that provides depth and immersion or a wide-angle horizontal field of view 2914 that enables a player to view a larger amount of the room. The vertical field of view 2916 typically remains the same. For example, if the system displays the poker table on a square display screen, the system might use a horizontal field of view 2912 of a 22 degree horizontal field of view and a vertical field of view 2916 of a 22 degree vertical field of view. However, if the system displays the poker table on a display screen with a 4:3 aspect ratio, the system might use a wide angle horizontal field of view 2914 of a 30 degree horizontal field of view with a vertical field of view 2916 of a 22 degree vertical field of view. The normal square 22 degree×22 degree perspective view could provide a view with depth and immersion of a particular part of the table while the wide-angle 30 degree×22 degree birdseye view enables a viewing of the entire table.

In another exemplary embodiment, camera 2930 could be aimed 33 degrees down from horizontal to capture the perspective view of the table. A typical camera has between 60 degrees 90 degrees vertical field of view 2916 that mimics the human field of view. But the perspective effect of this large vertical field of view on a computer screen can cause game elements further away appear too distant. In addition, the table rendered in this field of view does not effectively utilize screen real estate to provide a clear view of game elements. By narrowing the typical vertical field of view 2916 down to 22 degrees and by moving the camera farther away (to fit the entire table on screen), a sense of perspective is maintained so that the user still feels as if they are sitting in the table while reducing perspective distortion. In this setup, on a 4:3 ratio screen, a 30 degree horizontal field of view and 22 degree vertical field of view is preferred. In a 1:1 screen aspect ratio, both the vertical and horizontal fields of view should be 22 degrees. The horizontal field of view is derived as follows: hFOV=22/aspect ratio. The vertical field of view could be 18, 20, 22, 24, or 26 depending on a desired degree of perspective distortion.

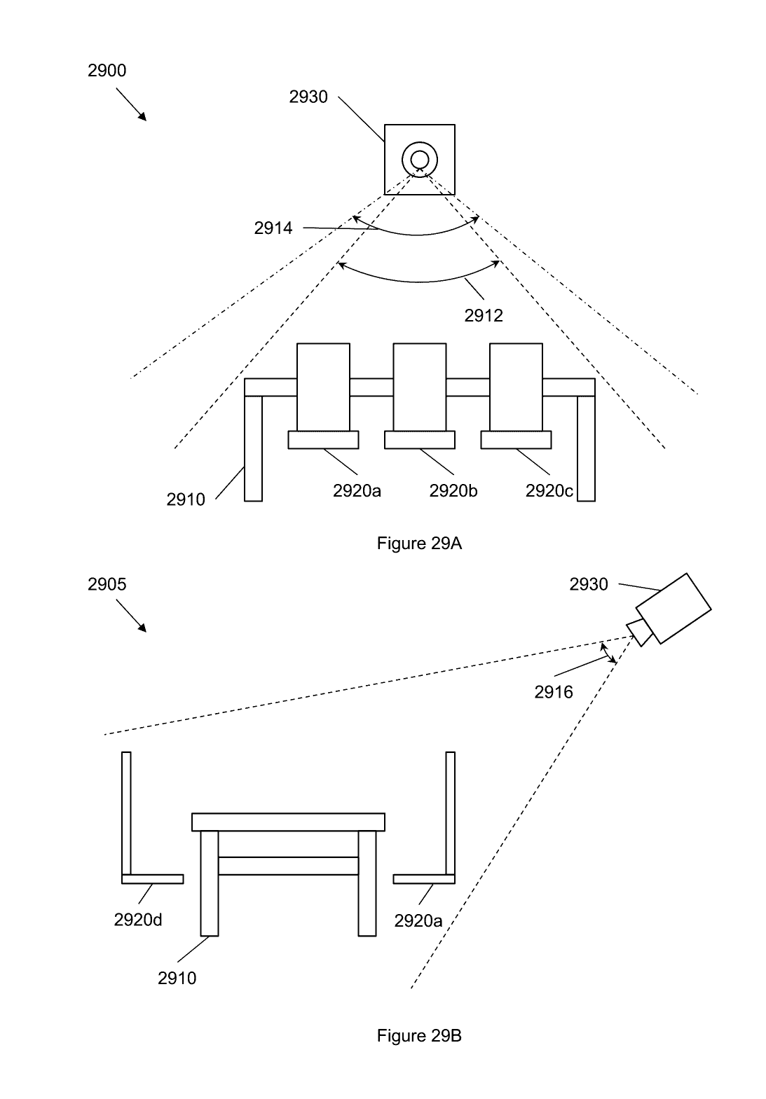

FIG. 30 shows an adjusted perspective view 3000 of the table 2910 of FIGS. 29A and 29B. A true scale model perspective view would cause player avatars 3020d, 3020e, and 3020f to appear smaller than avatars 3020a, 3020b, and 3020c. However, in some embodiments it is preferred to display all player avatars as the same size around the table. In these embodiments, to further reduce perspective distortion, player avatars 3020a, 3020b, and 3020c are shrunk slightly to match the sizes of player avatars 3020d, 3020e, and 3020f. Preferably, the system shrinks player avatars 3020a, 3020b, and 3020c by 5%, 10%, or even 20% such that player avatars 3020a, 3020b, and 3020c are about 80% of their original size.

FIG. 30 shows an adjusted perspective view 3000 of the table 2910 of FIGS. 29A and 29B. In preferred embodiments, perspective distortion is reduced by shrinking down the vertical field of view to 22 degrees. A true scale model perspective view would have player avatars 3020d, 3020e, and 3020f smaller than 3020a, 3020b, and 3020c. However, since it's preferred to display all player avatars as the same size around the table, player avatars 3020a, 3020b, and 3020c are shrunk slightly to match the sizes of player avatars 3020d, 3020e, and 3020f. Preferably, the system shrinks player avatars 3020a, 3020b, and 3020c by 5%, 10%, or even 20% such that player avatars 3020a, 3020b, and 3020c are about 80% of their original size. This saves bottom screen real estate for other uses (e.g., the user interface), and results in a perspective view of the game environment that efficiently utilizes screen real estate while maintaining a sense of immersiveness for the users. Likewise, in some embodiments, the bottom of perspective table 3010 is slightly shrunken compared to the top of perspective table 3010 such that the length of the top part of table 3010 is equal to the length of the bottom part of table 3010 (e.g., as in an orthographic view). This way, two-dimensional avatars (not shown) and cards and chips, all of the same size, could be inserted into adjusted perspective view 3000 without needing to alter the sizes of the two-dimensional images relative to the two-dimensional view taken from virtual camera 2930. By shrinking or altering the size of certain portions of a 2-D representation of the virtualized 3-D gameplay area, 2-D images could be overlaid on a perspective view without worrying about altering the perspective sizes of game elements.

The layout of FIG. 30 arranges three or four players on the top and bottom facing each other, instead of the typical arrangement where players sit around the table in oval, thus maximizing visibility of the avatars to a user while also maintaining a physical arrangement that prevents the appearance of avatars floating in the air. Typically the bottom row players' faces (2D profile pictures) would not be visible because they are facing away from the user towards the table. But by making the picture visible, and having them flipped and facing the table, physically correct seating and clear visibility of avatars is achieved even when they are facing towards the table.

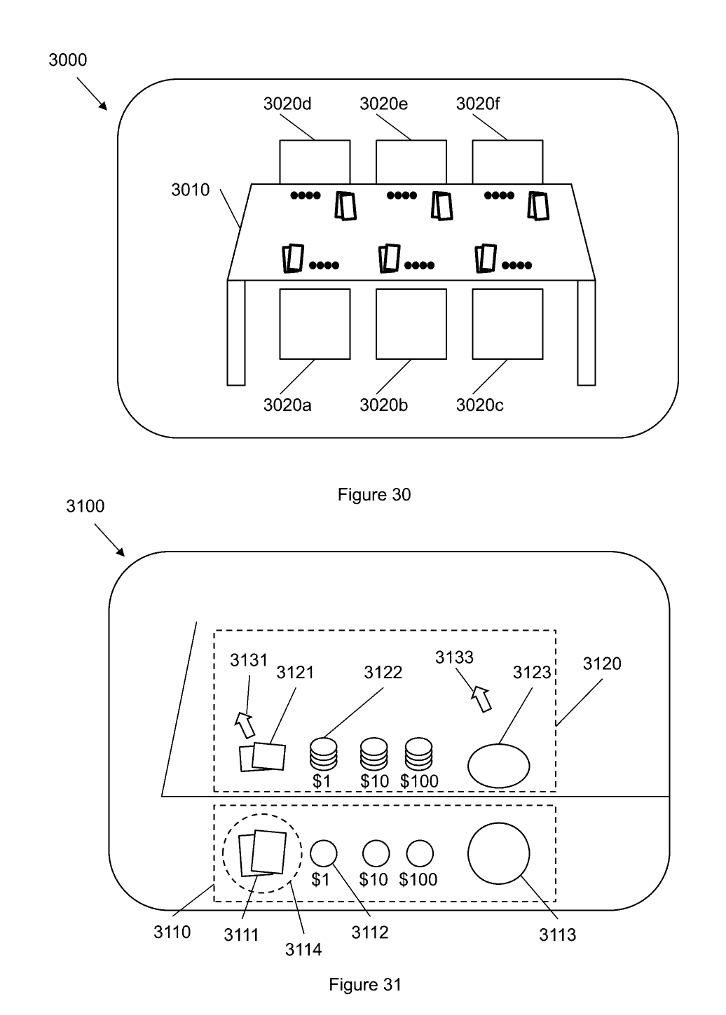

FIG. 31 shows a user interface 3100 showing a 2-D representation 3110 of the player's cards 3111, chips 3112, and staging area 3113, and a 3-D representation 3120 of the player's cards 3121, chips 3122, and staging area 3123. While user interface 3100 shows the table as being a zoomed-in representation of just the bottom left-hand side of the table, it is contemplated that the user interface could show a 3-D representation of the entirety of the table, above the 2-D representation of the player's cards, chips, and staging area. Typically, the interactions that the player has with the 2-D representation 3110 are synched with the 3-D representation 3120, such that when the player interacts with one of the elements in 2-D representation 3110, the corresponding element in 3-D representation 3120 changes accordingly in real-time. Typically, the system will show other players the same 3-D representation that the player sees, only from a different angle. (e.g., if the player tilts the cards towards the screen, other players will see the cards tilt away from their screen) While the user interface shows 3-D representation 3120 as being above 2-D representation 3110, 3-D representation 3120 could be arranged in any part of user interface 3100.

The 2-D representation has a set of origin points where, when a player touches an origin point on a touch screen or with a mouse, the system registers that the player is attempting to interact with a gameplay element. For example, circle 3114 could represent an area of user interface 3100 that, if the system detects the player touching a point within area 3114, the system could register that as a trigger for the player touching cards 3121. Preferably, the set of points is shaped like the 2-D representation itself, so that a player needs to touch a point on cards 3111 to interact with the cards, or touch a point on chips 3112 to interact with the chips. If the player keeps touching cards 3111 without removing the cards from area 3114, the system could recognize that the player wishes to look at the cards, and could then gradually tilt cards 3121 in 3-D representation 3120 towards the player in a spectrum. The longer the player touches a point in space 3114, the more cards 3121 would flip towards the player. In some embodiments, when the player touches and holds cards 3111, the 2-D representation would suddenly changes cards 3111 to show the values of the cards to the player. In other embodiments, when the player touches and holds cards 3111, cards 3111 could be grayed out, signaling that cards 3121 are tilting towards the player. As the cards tilt more and more towards the player, other players could see the cards tilting and possibly moving as the player moves his finger around area 3114, making it more and more obvious that the player is looking at his cards. When the player lets go of the screen, the system could translate that movement into an action slapping cards 3121 back down onto the table immediately, or could gradually tilt the cards face-down on the table in a reverse spectrum. In some embodiments, cards 3121 could be placed in a different position than they were in before the player touched cards 3111 to indicate that the player had looked at the cards. For example, cards 3121 could be rotated slightly or cards 3121 could be placed wherever the user lets go of the cards.

If, instead of keeping the finger within the area 3114, the player moves the finger outside of the area 3114, the system could calculate the distance and direction of the point where the finger touches the screen to an origin point of cards 3111, and could then draw an arrow 3131 above the 3-D representation of the cards 3121. Preferably, the arrow is drawn as a function of the distance and direction of the point where the finger touches the screen relative to the origin point of cards 3111, such that the arrow is larger when the finger is further away from the origin, and the arrow's direction matches the direction of the finger's point relative to the origin point. User interface 3100 could also position a pair of cards directly underneath the player's finger to show the player that the player is currently dragging the cards around the user interface. Preferably, the pair of cards directly underneath the player's finger are at least partially transparent so that the player can see parts of the user interface underneath the player's finger. The arrow 3131 is preferably duplicated in other user interfaces so that other players can see that the player is considering a fold of the player's cards. Preferably, the arrow is capped at a max distance away from the origin of cards 3111, such that when the user moves the finger beyond a threshold distance from the origin of cards 3111, the arrow does not grow any larger. Other indications could be provided to show where the player's finger is moving while the player is contemplating a fold, for example the arrow itself could have a level of transparency that is adjusted as a function of the distance the player's finger is from the point of origin of cards 3111. If the player releases the finger from the user interface after dragging the finger from card area 3114 to an area outside card are 3114, the system will preferably register that movement as a command to fold the cards. In some embodiments, cards 3121 will gradually then move towards the muck, but in other embodiments, cards 3121 will fly away from their origin position towards the direction of the arrow at a velocity that is calculated as a function of the point where the player's finger let go of user interface 3100 relative to the origin of cards 3111. In some embodiments, the system will cause arrow 3131 to fade away from the graphical representation of the player's object elements, and the cards will move towards the muck in both the player's user interface and the opponents' user interface.

Area 3113 represents a staging area that the player could drag chips 3112 towards. When a player touches any one of chips 3112 on user interface 3100, the system could register that as a motion to move chips towards the staging area for a bet. In some embodiments the user interface could then allow the player to drag one chip from the chip stack that the player touched to staging area 3113. In other embodiments when the player touches any one of chips 3112, a UI dial pops up around the stack of chips, allowing the player to select an amount of chips to move. The player could then drag the chips to the staging area, or in some embodiments the chips will simply automatically move the number of selected chips from the chip stack to the staging area. Chips that are in the staging area could also have a UI dial that acts similarly, allowing the player to move chips from the staging area back to the player's chip stacks. In this manner, the player could move chips to staging area 3113 for betting. Once an appropriate number of chips have been placed in the staging area, the player could touch any portion of area 3113 to contemplate betting the chips. Preferably, as chips are being moved from the player's chip stack to staging area 3113 and vice-versa, the chips are being moved in the 3D representation 3120, and also in other user interfaces of opponent players. Mistakes could also be transmitted, for example if a user accidentally lets go of a chip outside staging area 3113, the chip could fall in that place and gradually be returned to the chip stack.

Where the finger is touching area 3113, a dot (not shown) could appear on an equivalent place in 3-D staging area 3123. The dot in 3-D staging area 3123 could also be shown on opponent's user interfaces, showing opponents that the player is contemplating a bet. If the player's finger touches area 3113 when no chips are in the staging area, the dot could still be there to indicate that the player is considering an all-in. In some embodiments, the dot's transparency is drawn by the system as a function of how much pressure the player is applying to the user interface screen, giving other players a clue as to the player's mental state. When the player moves the finger outside of the staging area 3113, arrow 3133 could be drawn in a similar manner to arrow 3131—as a function of the distance and direction of the player's finger relative to an origin point of staging area 3113. If the player's finger moves back to staging area 3113, the arrow could disappear and a dot could, again, appear in the 3-D representation of staging area 3123.

Once a user touches 2-D staging area 3113, a dotted betting line (not shown) could be drawn in user interface 3110 (similar to all-in line 912) to indicate to the player where bets should be dragged towards. In other embodiments, the boundaries of the table are used to indicate this boundary. In either case, if the player lets go of the finger within the “common” area of the table, the system could indicate this as a bet, and could then move the designated chips in 3-D staging area 3123 towards the common area of the table. In some embodiments, the chips will be “splashed” into the table as a function of the distance and direction of the point where the player lets go of user interface 3100. The chips could be splashed in the common area at a high velocity if the finger is let go far away from the origin area of staging area 3113, or could be splashed at a low velocity if the finger is let go closer to the origin area of staging area 3113. In some embodiments, the system might restack the splashed chips into a stack in front of the player, and after the entire table as finished its round of betting, the stack of chips in front of the player could be relocated into a common stack in the middle of the table. All of the movements in 3-D representation area are preferably duplicated in the opponent's user interfaces (from the opponent's perspective of course). In this manner, the player can see what the player's inputs are translated into, while the player is inputting the movements.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps could be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of providing feedback during an electronic poker game between a first player using a first electronic device and a second player using a second electronic device, the method comprising:
receiving, from the first electronic device, an input corresponding to a contemplated interaction with a first user interface (UI) element but insufficient to complete the contemplated interaction; and
presenting, at the second electronic device, a graphical representation of the contemplated interaction in proximity to a different, second UI element.

2. The method of claim 1, wherein the contemplated interaction with the first UI element comprises at least one of: revealing a hand of cards, calling a bet, checking a bet, placing a bet, going all-in, selecting a quantity of a chip type, moving a card, folding a hand of cards, selecting a chip type, exchanging chip denominations, and folding.

3. The method of claim 1, wherein the first UI element represents an interactive object in the poker game.

4. The method of claim 1, wherein the graphical representation is presented in real-time with respect to receiving the input from the first electronic device.

5. The method of claim 1, wherein the graphical representation comprises an animation.

6. The method of claim 1, wherein the input comprises a value along a first spectrum.

7. The method of claim 6, wherein the value represents an extent to which the input contributes to completing the contemplated interaction.

8. The method of claim 6, wherein the graphical representation comprises a dynamic element changeable along a second spectrum.

9. The method of claim 8, wherein the dynamic element has a value that is proportional to the value of the input.

10. The method of claim 8, wherein the first and second UI elements both correspond to a same object in the poker game.

11. The method of claim 1, wherein the input comprises at least one of a force and pressure.

12. The method of claim 1, wherein the input comprises a gesture.

13. The method of claim 12, wherein the gesture contributes to a series of inputs that causes the hand of cards to be revealed as a function of the position and the pressure.

14. The method of claim 12, wherein the gesture contributes to a series of inputs that causes the hand of cards to be revealed as a function of the position and the time.

15. The method of claim 2, wherein the graphical representation comprises an indicator having a directional element oriented based on a direction derived from the gesture.

16. The method of claim 15, wherein the indicator also has an intensity element adjusted based on an intensity derived from the gesture.

17. The method of claim 1, further comprising:
detecting a first biometric from the first player and a second biometric from the second player; and
presenting the first biometric to the second player and the second biometric to the first player when presenting the graphical representation of the contemplated action.

18. The method of claim 17, wherein detecting is accomplished using first and second sensors, wherein at least one of the first and second biometric sensors is a wearable electronic device.

19. The method of claim 17, wherein at least one of the first and second biometrics comprises a heart rate.

20. The method of claim 17, wherein at least one of the first and second biometrics comprises a moisture level.

21. The method of claim 17, wherein at least one of the first and second biometrics comprises a voice pattern.

22. The method of claim 21, wherein the voice pattern comprises at least one of a pitch and a tone.

23. The method of claim 17, wherein at least one of the first and second biometrics comprises a hand movement.

24. The method of claim 17, wherein at least one of the first and second biometrics comprises a number of blinks.
